(19) United States
(12) Patent Application Publication
(10) Pub. No.: US 2026/0032801 A1
(43) Pub. Date: Jan. 29, 2026

(54) SHARED CIRCUITRY CONFIGURATIONS FOR PLASMA GENERATION

(71) Applicant: Champion Aerospace LLC, Liberty, SC (US)

(72) Inventor: Artur P. Suckewer, Franklin Park, NJ (US)

(21) Appl. No.: 19/284,670

(22) Filed: Jul. 29, 2025

Related U.S. Application Data
(60) Provisional application No. 63/676,745, filed on Jul. 29, 2024.

(51) Int. Cl. H05H 1/48

(52) U.S. Cl. CPC H05H 1/48

(57) ABSTRACT

The present disclosure provides shared circuitry configurations that may be implemented in a plasma generation system to improve control over application of electrical energy to a plasma generator, thereby providing improved performance. In some embodiments, shared circuitry configurations described herein may be implemented to improve performance of a traveling spark igniter that is configured to generate and propagate plasma using a Lorentz force and a thermal force, such as by applying electrical energy to electrodes of a plasma generator following breakdown between the electrodes. Other plasma generator configurations may also benefit from the circuitry configurations described herein.

### TECHNICAL FIELD

The present disclosure relates generally to plasma generation as may be implemented in an ignition system, such as for use in automotive and/or aerospace applications, but not limited thereto. More particularly, the present disclosure relates to configurations that multiplex stored electrical energy among multiple plasma generators for improved control over plasma generation thereby providing improved performance.

### BACKGROUND

A conventional ignition system (e.g., in an internal combustion engine) applies stored energy to electrodes of an igniter to cause breakdown between the electrodes, forming a substantially stationary plasma between the electrodes and proximate an air-fuel mixture to effect (e.g., ignite) the mixture. The energy used to achieve breakdown and form the stationary plasma is typically stored in an inductor or a capacitor, and all of the stored energy is discharged into the igniter during each ignition cycle. The inductor or capacitor is then refilled with electrical energy in between discharge events. In a conventional automotive ignition system, an ignition coil stores energy that is provided to multiple spark plugs over respective ignition cycles using a distributor. The ignition coil is fully discharged into a given spark plug while that spark plug is connected to the distributor and then the ignition coil is recharged before the distributor connects to another spark plug.

A traveling spark igniter was previously developed for use in internal combustion engines. Traveling spark igniters generate a plasma kernel by applying a sufficiently high voltage between electrodes of the igniter to cause breakdown between the electrodes, at which point plasma is formed at the location of breakdown and is then propagated along the electrodes. Propagation is caused by Lorentz and thermal forces due to discharge current flowing between the electrodes through the plasma and interacting with a field created, at least in part, by current flowing in the electrodes.

More recently, traveling spark igniters have been developed that apply one or more follow-on pulses of current to the electrodes following breakdown and prior to total recombination of the plasma. The follow-on pulses are used to generate corresponding pulses of Lorentz force and thermal forces to grow and propagate the formed plasma along the electrodes.

### SUMMARY

According to an aspect of the present disclosure, a plasma generation system is provided, the system comprising: a plurality of plasma generators, each plasma generator comprising at least two electrodes configured to form plasma between the at least two electrodes of the plasma generator when a breakdown voltage sufficient to induce breakdown between the at least two electrodes is applied thereto; and circuitry configured to, for each of the plurality of plasma generators, following breakdown, control application of electrical energy to the at least two electrodes of the plasma generator, the application of electrical energy to the at least two electrodes being along a shared electrical energy flow path that is shared by each of the plurality of plasma generators.

According to an aspect of the present disclosure, a plasma generation system is provided, the system comprising: a plurality of plasma generators, each plasma generator comprising at least two electrodes configured to form plasma between the at least two electrodes of the plasma generator when a breakdown voltage sufficient to induce breakdown between the at least two electrodes is applied thereto; and a controlled energy discharge path configured to apply, to the at least two electrodes of each of the plurality of plasma generators, electrical energy sufficient to propagate the plasma toward a distal tip of the at least two electrodes.

According to an aspect of the present disclosure, a plasma generation system is provided, the system, comprising: a plurality of plasma generators, each plasma generator comprising at least two electrodes configured to form plasma between the at least two electrodes of the plasma generator when a breakdown voltage sufficient to induce breakdown between the at least two electrodes is applied thereto; an energy storage device; and circuitry coupled to the energy storage device and to each of the plurality of plasma generators and configured to deliver electrical energy from the energy storage device to each of the plurality of plasma generators, wherein the energy storage device is configured to store an amount of electrical energy greater than needed to apply the breakdown voltage to each of the plurality of plasma generators collectively.

According to an aspect of the present disclosure, an ignition system is provided, the ignition system comprising: a first igniter comprising a first plurality of electrodes; a second igniter comprising a second plurality of electrodes; and a controlled energy discharge path configured to: apply a first pulse of electrical energy to the first plurality of electrodes following breakdown between the first plurality of electrodes; and apply a second pulse of electrical energy to the second plurality of electrodes following breakdown between the second plurality of electrodes.

According to an aspect of the present disclosure, a plasma generation system is provided, the system comprising: a plurality of plasma generators, each plasma generator comprising at least two electrodes; a plurality of energy flow paths to the plurality of plasma generators, respectively, wherein the plurality of energy flow paths share a shared circuit component; and a plurality of transformers, for each of the plurality of plasma generators, respectively, each transformer comprising: a primary coil configured to trigger breakdown between the at least two electrodes, resulting in formation of plasma between the at least two electrodes; and a secondary coil configured to receive, along the energy flow path to the plasma generator and via the shared circuit component, electrical energy for applying to the at least two electrodes following breakdown.

According to an aspect of the present disclosure, a plasma generation system is provided, the system comprising: a plurality of plasma generators, each plasma generator comprising at least two electrodes configured to form plasma between the at least two electrodes of the plasma generator when a breakdown voltage sufficient to induce breakdown between the at least two electrodes is applied thereto; an energy storage device; and circuitry configured to: apply, to each of the plurality of plasma generators, using electrical energy stored in the energy storage device, a pulse of electrical energy; and for each of the plurality of plasma generators, terminate application of the pulse of electrical energy with at least some electrical energy remaining stored in the energy storage device.

The foregoing summary is not intended to be limiting. Moreover, aspects of the present disclosure may be implemented individually or in combination depending on the particular application.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 illustrates an example plasma generation system including a controlled energy discharge path with plasma generation circuitry configured to apply electrical energy to multiple plasma generators, according to some embodiments.

FIG. 2 illustrates an example plasma generation system including plasma generation circuitry having a shared circuit component coupled to multiple plasma generators, according to some embodiments.

FIG. 3A illustrates an example plasma generation system including an energy storage device and multiplexing circuitry configured to apply electrical energy from the energy storage device to multiple plasma generators, according to some embodiments.

FIG. 3B illustrates an example plasma generation system including plasma generation circuitry having a shared circuit component coupled to a respective transformer for each plasma generator, according to some embodiments.

FIG. 4 illustrates an example plasma generation system including a cross-section of at least two electrodes and circuitry configured to apply electrical energy to the electrode(s), according to some embodiments.

FIG. 5A illustrates example application of electrical energy to a first plasma generator, according to some embodiments.

FIG. 5B illustrates example application of electrical energy to a second plasma generator at the same time as the first plasma generator, according to some embodiments.

FIG. 5C illustrates an alternative example application of electrical energy to the second plasma generator of FIG. 5B at least partially at the same time as the first plasma generator, according to some embodiments.

FIG. 5D illustrates an alternative example application of electrical energy to the first plasma generator of FIG. 5A, according to some embodiments.

FIG. 6 illustrates example plasma generation circuitry including switching elements coupled between an energy storage device and multiple plasma generators, respectively, according to some embodiments.

FIG. 7 illustrates example plasma generation circuitry including an energy storage device having multiple capacitive portions, according to some embodiments.

FIG. 8 illustrates example plasma generation circuitry including breakdown circuitry and current control circuitry that is switchable to draw electrical energy from an energy storage device to a plasma generator, according to some embodiments.

FIG. 8 is a schematic of an example plasma generation system having two plasma generators, two channels of plasma generation circuitry, and shared circuitry that is used by both channels.

### DETAILED DESCRIPTION

The present disclosure provides shared circuitry configurations that may be implemented in a plasma generation system to improve control over application of electrical energy to a plasma generator, thereby providing improved performance. In some embodiments, shared circuitry configurations described herein may be implemented to improve performance of a traveling spark igniter that is configured to generate and propagate plasma using a Lorentz force and a thermal force, such as by applying electrical energy to electrodes of a plasma generator following breakdown between the electrodes. It is recognized that other plasma generator configurations may also benefit from the circuitry configurations described herein.

Some aspects of the present disclosure leverage a recognition that it may be beneficial in some implementations of a plasma generation system to share a circuit element and/or energy flow path among multiple plasma generators. For example, in a plasma generation system including circuitry configured to apply electrical energy to electrodes of multiple plasma generators following breakdown (e.g., in the plasma generator to which the electrical energy is applied), it may be advantageous to apply follow-on electrical energy (e.g., to prevent total recombination of plasma formed at breakdown, and/or to propagate the plasma along the electrode) using a shared circuit component and/or energy flow path, such as including and/or from a shared energy storage device (e.g., capacitor) and/or shared inductance (e.g., storing magnetic energy for providing as electrical energy). For instance, it is recognized that sharing a circuit element and/or energy flow path among multiple plasma generators may be more efficient due to using fewer components and/or reducing the likelihood that a component fails as compared to when a circuit element and/or energy flow path is not shared. Some conventional ignition systems have shared components that apply a breakdown voltage to multiple igniters by emptying all available electrical energy into an igniter in an uncontrolled manner. For example, where a capacitor or ignition coil is shared among multiple igniters, energy is emptied from the capacitor or ignition coil into a given igniter until the energy is exhausted, at which point the ignition cycle ends and the capacitor or ignition coil is recharged. In contrast, in some aspects of the present disclosure, electrical energy may be controllably applied following breakdown and/or may be applied to cause propagation of plasma along the electrodes of a plasma generator, which may benefit in ways beyond using fewer parts that do not apply in the context of conventional ignition systems.

According to an aspect of the present disclosure, a plasma generation system may include a plurality of plasma generators and circuitry (e.g., plasma generation circuitry) configured to control application of electrical energy to the electrodes of each plasma generator, with the application of electrical energy being along a shared electrical energy flow path that is shared by each of the plasma generators. For example, the shared electrical energy flow path may be a portion at which energy flow paths to the multiple plasma generators overlap, such that energy flowing to any of the plasma generators passes through at least that shared path portion. It is recognized that a shared electrical energy flow path for controlled application of electrical energy may provide advantages not present when a shared flow path is only used for uncontrolled application of electrical energy. For instance, controlled application of energy may permit a shared flow path to provide electrical energy to multiple plasma generators without fully recharging the source of the electrical energy in between, and even provide electrical energy to multiple plasma generators simultaneously, as energy may not need to be depleted from the source prior to termination of application of the energy like in a conventional ignition system.

According to an aspect of the present disclosure, a plasma generation system may include a plurality of plasma generators and a controlled energy discharge path configured to apply, to the electrodes of each of the plasma generators, electrical energy sufficient to propagate plasma, formed between the electrodes, toward a distal tip of the electrodes. For example, the controlled energy discharge path may be a path having circuitry along it and/or coupled to it that controls the flow of electrical energy along the path. It is recognized that a controlled discharge path may provide electrical energy to multiple plasma generators to achieve plasma propagation without fully recharging the source of the electrical energy in between, and even provide electrical energy to multiple plasma generators simultaneously, as energy may not need to be depleted from the source prior to termination of application of the energy like in a conventional ignition system.

According to an aspect of the present disclosure, an ignition system may include a first igniter, a second igniter, and a controlled energy discharge path configured to apply pulses of electrical energy to electrodes of each of the first igniter and the second igniter, the pulses being applied following breakdown in the respective igniter. For example, breakdown and/or application of pulses may be applied to each igniter one at a time and/or at least partially overlapping in time. It is recognized that a controlled discharge path may provide electrical energy to multiple plasma generators following breakdown without fully recharging the source of the electrical energy in between, and even provide electrical energy to multiple plasma generators simultaneously, as energy may not need to be depleted from the source prior to termination of application of the energy like in a conventional ignition system.

According to an aspect of the present disclosure, a plasma generation system may include a plurality of plasma generators, a plurality of energy flow paths to the plasma generators, respectively, that share a shared circuit component, and a plurality of transformers for each of the plasma generators. For example, each transformer may have a primary coil configured to trigger breakdown in the respective plasma generator and a secondary coil configured to receive electrical energy via the respective energy flow path and via the shared circuit component for applying to the respective plasma generator. For instance, breakdown may be achieved based on a voltage across the secondary coil produced when current passes through the primary coil, and the energy flow path may be configured to provide current that also passes through the shared circuit component and the secondary coil following breakdown. It is recognized that having energy flow paths from a shared circuit component via secondary coils to respective plasma generators, beyond the primary coils that trigger breakdown, may permit controlled application of electrical energy to multiple plasma generators without needing to fully recharge the source of the electrical energy in between, and even provide electrical energy to multiple plasma generators simultaneously, as energy may not need to be depleted from the source prior to termination of application of the energy like in a conventional ignition system.

Some aspects of the present disclosure leverage a recognition that an electrical energy storage device shared among multiple plasma generators may provide a stable energy source (e.g., with a substantially constant voltage over time). For example, sharing energy storage among multiple plasma generators may present a larger effective capacitance to each plasma generator than if only individual energy storage devices were coupled to each plasma generator, such that electrical energy may be more stably supplied than only using individual storage devices.

In a conventional ignition system, however, the size of the capacitance storing the available ignition energy for an igniter defines both the amount of electrical energy applied to the igniter and the timing by which the electrical energy will be applied. This is because all electrical energy in the capacitance is depleted during each ignition cycle, and thus the ignition cycle does not end until the electrical energy is depleted. As such, in a conventional ignition system, the option of using a large, shared capacitance is hindered by other factors such as the desired ignition timing and quantity of ignition energy.

Overcoming these drawbacks of conventional ignition systems, an aspect of the present disclosure provides a plasma generation system in which electrical energy is controllably applied (e.g., to grow and propagate plasma, such as in a traveling spark igniter) while leveraging a large, shared energy storage device (e.g., capacitor) to provide a stable energy source (e.g., with a substantially constant voltage over time). For example, plasma sustenance and/or propagation may be achieved by applying a controlled pulse of electrical energy from a shared energy storage device to multiple plasma generators (e.g., at the same time, different times, and/or partially overlapping times), such as using a switching element (e.g., for each plasma generator) to control application of electrical energy from the shared energy storage device to a given plasma generator. As such, the amount of electrical energy delivered and the timing of application of electrical energy may be controlled at least somewhat independently from the capacity and/or capacitance of the shared energy storage device. For instance, a relatively small amount of electrical energy (e.g., as compared to fully depleting a capacitance in a conventional ignition system) may be controllably applied to a plasma generator from a shared energy storage device and then application of electrical energy may be terminated before substantially depleting the charge stored in the energy storage device, resulting in a stable (e.g., substantially constant voltage) being available from the energy storage device. Further, even where a particular application involves substantial or complete depletion of the energy stored, the use of a shared energy storage device among two or more plasma generators still advantageously provides an overall system having a reduced component count and reduced total physical space required by the system.

According to an aspect of the present disclosure, a plasma generation system may include circuitry (e.g., plasma generation circuitry) coupled to an energy storage device and to each of a plurality of plasma generators and configured to deliver at least some electrical energy from the energy storage device to each of the plasma generators, the energy storage device being configured to store an amount of electrical energy greater than needed to apply the breakdown voltage to each of the plasma generators collectively (e.g., one at a time and/or at least partially overlapping in time). For example, the energy storage device may be configured to store enough electrical energy to deliver the breakdown voltage to each plasma generator via the circuitry (e.g., one at a time and/or at least partially at the same time) and still have electrical energy remaining stored in the energy storage device. It is recognized that sharing an energy storage device among multiple plasma generators in this manner may leverage a large capacity and/or capacitance of the energy storage device for a stable energy supply while providing for control over the timing of and/or amount of electrical energy delivered to the plasma generator(s) for improved performance.

According to various embodiments, the energy storage device may be configured to store at least 150%, and/or at least 200% of electrical energy needed to apply a breakdown voltage and follow-on energy to each of the plasma generators collectively, though more or less electrical energy may be stored in the energy storage device depending on the implementation. For instance, in some embodiments, the energy storage device may be configured to store enough electrical energy to apply a breakdown voltage to each of the plasma generators collectively and further apply to at least one of the plasma generators electrical energy sufficient to prevent total recombination of plasma formed between the electrodes of the plasma generator(s).

According to an aspect of the present disclosure, a plasma generation system may include circuitry (e.g., plasma generation circuitry) configured to apply, to at least two electrodes of each of a plurality of plasma generators, a pulse of electrical energy using electrical energy stored in an energy storage device. For example, the circuitry may be configured to distribute electrical energy among plasma generators for applying a respective pulse to each plasma generator. In some embodiments, the circuitry may be further configured to, for each of the plasma generators, terminate application of the pulse of electrical energy with at least some electrical energy remaining stored in the energy storage device. For example, there may be electrical energy remaining stored in the energy storage device following termination of electrical energy to each plasma generator individually and also collectively after each plasma generator has received its respective pulse of electrical energy. It is recognized that terminating application of electrical energy to a plurality of plasma generators with at least some electrical energy remaining stored in the energy storage device may thereby leverage a large capacity and/or capacitance of the energy storage device for a stable energy supply while providing for control over the timing of and/or amount of electrical energy delivered to the plasma generator(s) for improved performance.

According to various embodiments, the energy storage device may continue to store at least enough electrical energy to prevent total recombination of plasma formed between electrodes of a plasma generator, and/or at least enough electrical energy to propagate plasma along the electrodes of a plasma generator, though in some cases the energy storage device may continue to store enough electrical energy to prevent total recombination of plasma and/or to propagate plasma for each of the plasma generators, as embodiments described herein are not so limited.

It should be appreciated that, according to various embodiments, aspects of the present disclosure may be implemented individually or in suitable combination.

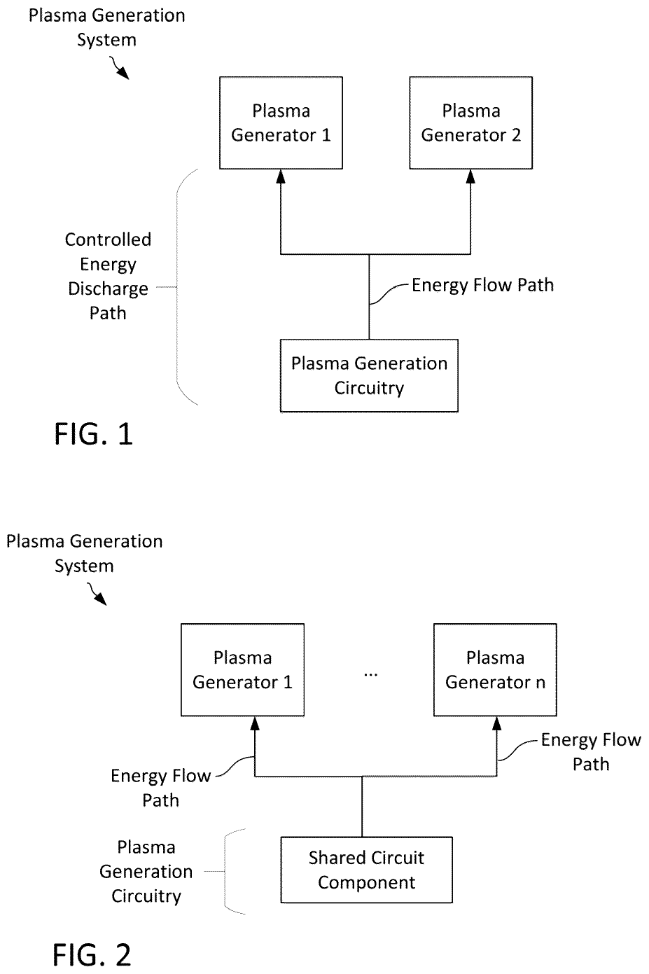

Turning to the figures, FIG. 1 illustrates an example plasma generation system including a controlled energy discharge path with plasma generation circuitry configured to apply electrical energy to multiple plasma generators, according to some embodiments.

In the illustrated embodiment, the plasma generation system includes a plurality of plasma generators and plasma generation circuitry. In some embodiments, the plasma generation system of FIG. 1 may be implemented as at least a portion of an ignition system, for instance, with at least one of the plasma generators being configured as an igniter. It should be appreciated that plasma generators and circuitry described herein may be implemented in non-igniter configurations, such as where plasma is generated for purposes other than to ignite an air-fuel mixture.

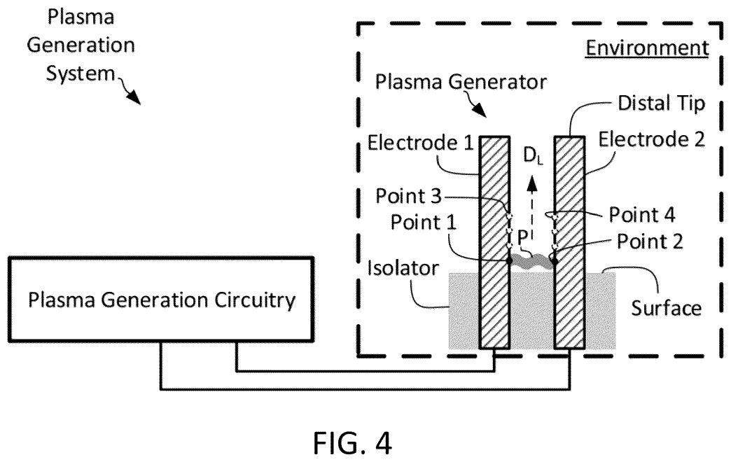

In some embodiments, a plasma generation system such as shown in FIG. 1 may include a plurality of plasma generators. For example, in FIG. 1, a first plasma generator 1 and a second plasma generator 2 are shown included in the plasma generation system, though any number of plasma generators may be included depending on the application. In some embodiments, each plasma generator may include at least two electrodes configured to form plasma between the at least two electrodes when a voltage sufficient to induce breakdown between the at least two electrodes is applied thereto, such as described further herein including in connection with FIG. 4.

According to an aspect of the present disclosure, a plasma generation system such as shown in FIG. 1 may include circuitry configured to, for each of the plasma generators, control application of electrical energy to the electrodes of the plasma generator. For example, the plasma generation circuitry shown in FIG. 1 may be configured to control application of electrical energy to the first plasma generator 1 and to the second plasma generator 2. For instance, the plasma generation circuitry may be configured to apply pulses of electrical energy to the first plasma generator 1 and/or the second plasma generator 2, whether at different times and/or at least at partially overlapping times. As described further herein, plasma generation circuitry may include one or more switching elements (e.g., a switching element for each plasma generator) configured to control application of electrical energy to the plasma generators.

In some embodiments, application of electrical energy to the electrodes of each plasma generator may be along a shared electrical energy flow path that is shared by each of the plasma generators. For example, in FIG. 1, the first plasma generator 1 and the second plasma generator 2 are coupled to the plasma generation circuitry by an energy flow path that splits into multiple path segments to the respective plasma generators. For instance, a flow path from the plasma generation circuitry to any given plasma generator may pass through the shared energy flow path and further through a path segment not shared with the other plasma generators.

In some embodiments, a plasma generation system such as shown in FIG. 1 may include a controlled energy discharge path configured to apply electrical energy to the electrodes of each plasma generator. For example, as shown in FIG. 1, the controlled energy discharge path includes at least the illustrated portion of the plasma generation circuitry and flow paths from the plasma generation circuitry to each plasma generator. For instance, the controlled energy discharge path may include any path segments along which application of electrical energy is controlled (e.g., using the plasma generation circuitry).

In some embodiments, the plasma generation system shown in FIG. 1 may be implemented as at least a portion of an ignition system, such as with the first plasma generator 1 being a first igniter having first electrodes, the second plasma generator 2 being a second igniter having second electrodes, and the controlled energy discharge path being configured to apply a pulse of electrical energy to the first electrodes (e.g., following breakdown between the first electrodes) and apply a pulse of electrical energy to the second electrodes (e.g., following breakdown between the second electrodes), whether at different times and/or at least partially overlapping in time.

In some embodiments, the plasma generation circuitry may be configured to control application of electrical energy to the plasma generators via the shared energy flow path. For example, the plasma generation circuitry may include multiplexing circuitry interconnecting each of the plasma generators to the shared energy flow path to deliver electrical energy via the energy flow path to each of the plasma generators. For instance, the multiplexing circuitry may include, for each of the plasma generators, a respective switching element coupled to the plasma generator and configured to control coupling between the plasma generator and the shared energy flow path. It should be appreciated that such switching elements may be coupled between the plasma generators and the shared energy flow path, and/or may be coupled after the plasma generators (e.g., between each plasma generator and a ground return path). It should also be appreciated that switching elements may not be included for at least some plasma generators, such as where electrical energy may be controllably applied to multiple plasma generators at the same time (e.g., and not independently).

In some embodiments, application of electrical energy to the electrodes of each plasma generator may be controlled at least following breakdown in the respective plasma generator. For example, prior to the plasma generation circuitry controlling application of electrical energy to a given plasma generator, a breakdown voltage may have already been applied to the plasma generator (e.g., using the same and/or different plasma generation circuitry). For instance, the plasma generation circuitry may be configured to control application of follow-on electrical energy to each plasma generator following breakdown in that plasma generator. This is in contrast to conventional ignition systems in which, following breakdown, electrical energy is only applied to an igniter in an uncontrolled manner, such as oscillating between a capacitor and an ignition coil to sustain the plasma formed at breakdown.

According to various embodiments, electrical energy controllably applied to electrodes of a plasma generator following breakdown may include a pulse of electrical energy sufficient to prevent total recombination of plasma formed between the electrodes of the plasma generator to which the electrical energy is applied, and/or sufficient to propagate the plasma formed between the electrodes along the length of the electrodes, and/or sufficient to move a point at which (e.g., to and/or from which) electrical energy is discharged from the electrodes, and/or sufficient to produce a Lorentz force component along the electrodes, as described further herein including in connection with FIG. 4.

In some embodiments, application of electrical energy to each plasma generator may be actively controlled following breakdown. For example, active control of electrical energy to a given plasma generator following breakdown may include use of an active element (e.g., switching element and/or diode) to initiate, terminate, and/or adjust application of electrical energy at a time following breakdown. For instance, following breakdown, application of electrical energy may be actively initiated, terminated, and/or adjusted to achieve an actively controlled amount of electrical energy discharged from the electrodes through plasma between the electrodes. In some cases, active control may further include a feedback loop sensing current flowing between the electrodes through the plasma.

FIG. 2 illustrates an example plasma generation system including plasma generation circuitry having a shared circuit component coupled to multiple (1 to n) plasma generators, according to some embodiments.

In some embodiments, the plasma generation system shown in FIG. 2 may be configured as described herein including in connection with FIG. 1, such as including a plurality of plasma generators and plasma generation circuitry. In the illustrated embodiment, the plasma generation circuitry includes a shared circuit component that is coupled to each of the plasma generators via a shared energy flow path. For example, in the illustrated embodiment, electrical energy applied to each plasma generator (e.g., at least following breakdown) may be via the shared circuit component.

According to various embodiments, the shared circuit component may include a shared energy storage device, a shared inductance, and/or a shared switching element. For example, a shared energy storage device may be configured for controlled application of electrical energy to each plasma generator (e.g., at least following breakdown), as may provide a large pool of available electrical energy shared among multiple plasma generators. For instance, a shared energy storage device may include a shared capacitor configured to deliver electrical energy to each of the plasma generators, for instance, providing a capacitance that is shared among the plasma generators.

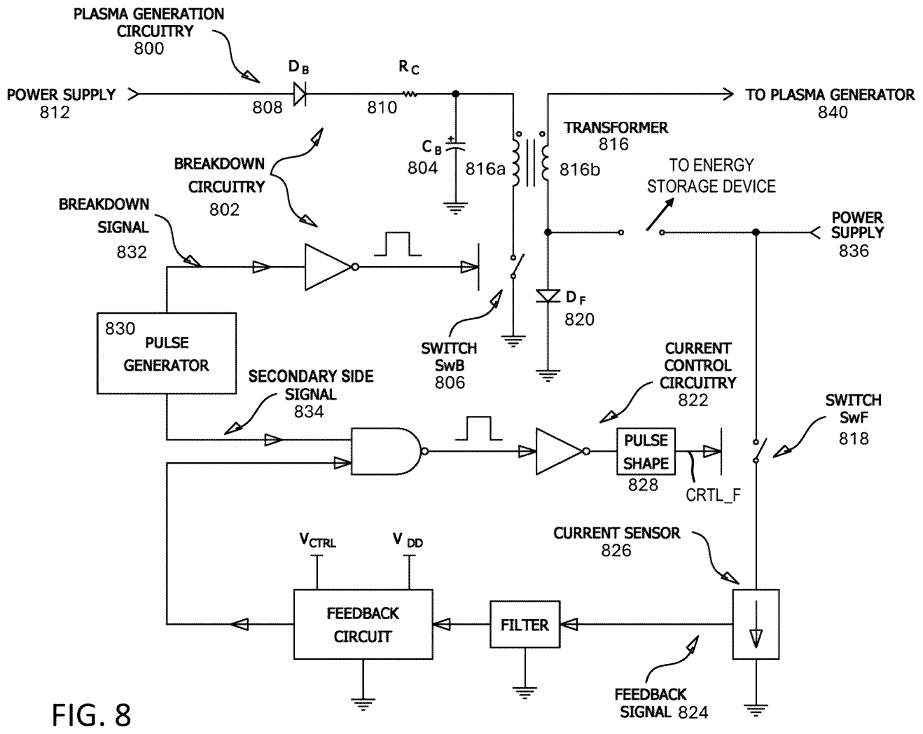

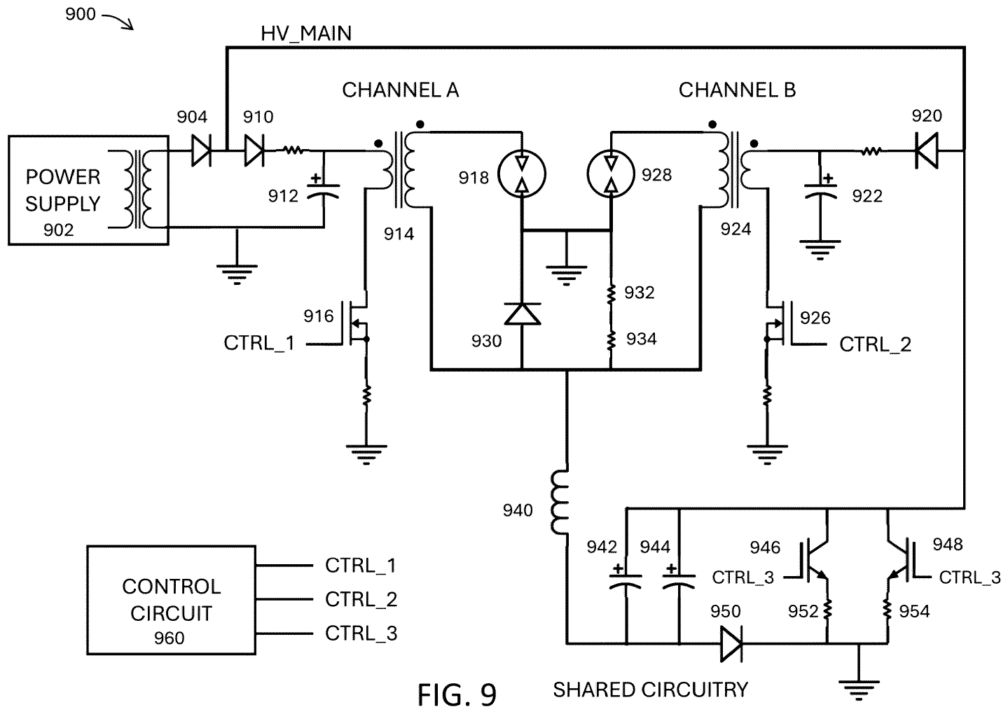

Alternatively or additionally, a shared inductance may be configured for controlled application of electrical energy to each plasma generator, which may similarly provide a shared pool of available energy (e.g., magnetic energy to be converted to electrical energy), or may be switchable among plasma generators when providing a relatively small amount of energy to each (e.g., sufficient to prevent total recombination of formed plasma). In some embodiments, a shared inductance may include a secondary coil of a transformer (e.g., in which the primary coil may be used to trigger breakdown), for example with the transformer having a saturable core, such as described further herein including in connection with FIG. 8. As yet another example, a switching element may be shared among multiple plasma generators, such as when at least one aspect of controlling application of electrical energy (e.g., before, at, and/or following breakdown) is shared by multiple plasma generators.

In some embodiments, a controlled energy discharge path (e.g., FIG. 1) may include a shared circuit component such as described in connection with FIG. 2. For example, along the path, a shared circuit component may be configured to provide and/or conduct electrical energy in a controlled (e.g., switchable) manner, such as described herein.

In the illustrated embodiment, the shared circuit component is shown at the end of the shared energy flow path that splits out to reach the plasma generators, though it should be appreciated that further circuitry may be coupled along the shared energy flow path before the shared circuit component.

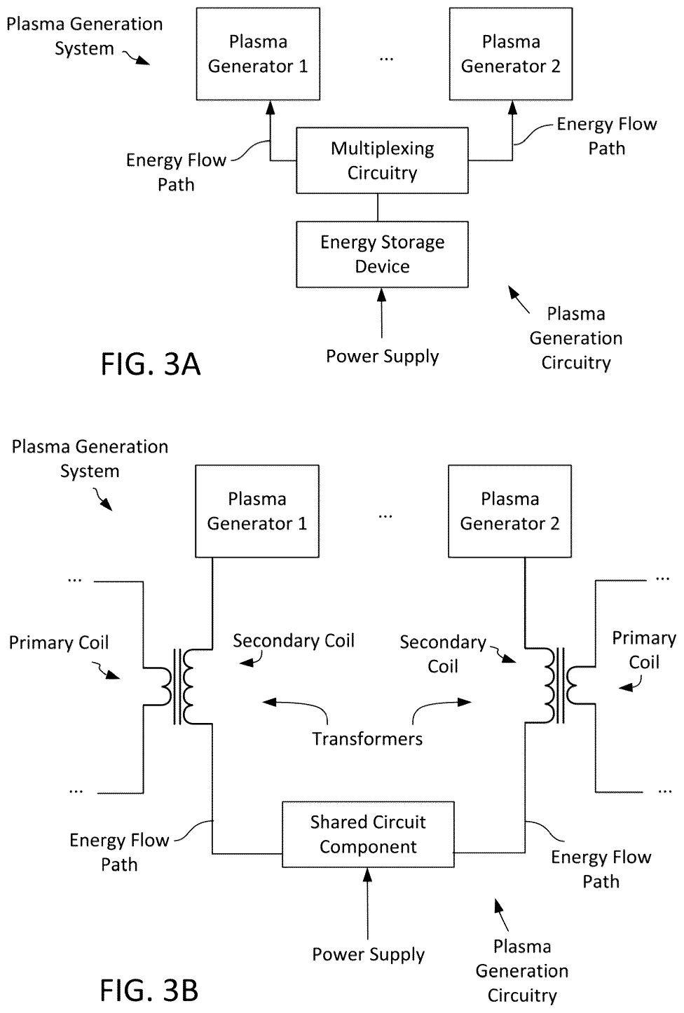

FIG. 3A illustrates an example plasma generation system including circuitry configured to multiplex stored electrical energy from an energy storage device among multiple plasma generators, according to some embodiments.

In some embodiments, the plasma generation system shown in FIG. 3A may be configured as described herein including in connection with FIG. 2 such as including a plurality of plasma generators and plasma generation circuitry that includes a shared circuit component. In the illustrated embodiment, the shared circuit component includes an energy storage device. For example, in the illustrated embodiment, multiplexing circuitry is interconnected between the energy storage device and the plasma generators.

According to an aspect of the present disclosure, a plasma generation system such as shown in FIG. 3A may include an energy storage device and circuitry configured to apply a pulse of electrical energy to each of the plasma generators using electrical energy stored in the energy storage device. For example, as shown in FIG. 3A, the plasma generation circuitry includes multiplexing circuitry coupled between the energy storage device and the first plasma generator 1 and the second plasma generator 2. For instance, the multiplexing circuitry may be configured to controllably discharge electrical energy stored in the energy storage device to a selected one or more of the plasma generators.

In some embodiments, the circuitry may be further configured to, for each of the plasma generators, terminate application of the pulse of electrical energy with at least some electrical energy remaining stored in the energy storage device. For example, in FIG. 3A, the multiplexing circuitry may be configured to decouple the energy storage device from any or all plasma generators to terminate application of the pulse of energy, even when there is electrical energy remaining in the energy storage device. This is in contrast to conventional ignition systems in which termination of application of electrical energy results from the energy storage device being depleted of its stored electrical energy (e.g., at least such that insufficient electrical energy remains for a useful ignition purpose). It is recognized that using circuitry to apply pulses of electrical energy from a shared energy storage device to multiple plasma generators, using termination of application of electrical energy with at least some energy remaining in the energy storage device, may leverage a large capacity and/or capacitance of the energy storage device for a stable energy supply while providing for separate control over the timing of and/or amount of electrical energy delivered to the plasma generator(s) for improved performance.

In some embodiments, a controlled energy discharge path such as shown in FIG. 1 may be configured to terminate application of electrical energy to a plasma generator with at least some electrical energy remaining in a shared energy storage device, such as where a shared circuit component is included in the controlled energy discharge path as shown in FIG. 2, and where the shared circuit component includes an energy storage device such as shown in FIG. 3A.

According to various embodiments, the pulse of applied electrical energy may be sufficient to prevent total recombination of plasma formed between the electrodes, and/or sufficient to propagate plasma formed between the electrodes toward a distal tip of the electrodes, and/or sufficient to move a point of discharge of electrical energy from the electrodes, and/or sufficient to produce a Lorentz force component along the at least two electrodes. Alternatively or additionally, the pulse of electrical energy may be sufficient to prevent total recombination of plasma formed as a result of application of the breakdown voltage to the plasma generator to which the pulse of electrical energy is applied (e.g., with breakdown being applied using the same and/or different plasma generation circuitry).

According to various embodiments, for each of the plasma generators, electrical energy remaining stored in the energy storage device following termination of the pulse of electrical energy may be sufficient to prevent total recombination of plasma formed between the electrodes of at least one of the plasma generators. For example, there may be sufficient electrical energy left in the energy storage device following termination of application of electrical energy that further electrical energy may be usefully applied to at least one plasma generator, which is in contrast to conventional ignition systems such as described above.

According to another aspect of the present disclosure, a plasma generation system such as shown in FIG. 3A may include circuitry coupled to an energy storage device and to each of a plurality of plasma generators and configured to deliver electrical energy from the energy storage device to each of the plasma generators, the energy storage device being configured to store an amount of electrical energy greater than needed to apply the breakdown voltage to each of the plasma generators collectively. For example, the energy storage device may be configured to store enough energy that, had the energy storage device delivered the breakdown voltage to each of the plasma generators collectively (e.g., one at a time and/or at least partially overlapping in time), more energy would remain stored in the energy storage device. It is recognized that applying electrical energy from such a large, shared energy storage device to multiple plasma generators may leverage a large capacity and/or capacitance of the energy storage device for a stable energy supply while providing for separate control over the timing of and/or amount of electrical energy delivered to the plasma generator(s) for improved performance. It should be appreciated that such a plasma generation system need not actually apply breakdown electrical energy to some or even any of the plasma generators, as these advantages apply even where the energy storage device is only used to provide electrical energy following breakdown (e.g., to propagate plasma along the electrodes).

According to various embodiments, the energy storage device may be configured to store an amount of electrical energy sufficient to, after applying the breakdown voltage to each of the plasma generators, further apply the breakdown voltage to at least one of the plasma generators, and/or further apply follow-on energy sufficient to prevent total recombination of plasma formed between the electrodes of the plasma generator. For example, the follow-on energy may be sufficient to propagate the plasma toward a distal tip of the electrodes and/or to move a point at which electrical energy is discharged to and/or from the electrodes. According to various embodiments, the follow-on energy may be applied to a plasma generator, such as following termination of a pulse of electrical energy to the same and/or another plasma generator, and/or as the pulse of electrical energy that is terminated.

According to various embodiments, the energy storage device may be configured to store an amount of electrical energy that is at least 150%, and/or at least 200%, of electrical energy needed to apply, to each of the plasma generators collectively (e.g., one at a time and/or at least partially overlapping in time), a breakdown voltage and follow-on electrical energy sufficient to prevent total recombination of plasma formed by the breakdown voltage. For example, in contrast to a conventional ignition system in which electrical energy is fully depleted when provided to each igniter, thus resulting in an unstable voltage supply towards the tail end of depleting the available energy, the amount of energy stored according to some aspects described herein may be large enough that a stable voltage supply is available to the plasma generators for most if not all electrical energy provided to the plasma generators.

In some embodiments, a energy storage device (e.g., and/or a shared capacitor thereof) may be configured to store an amount of electrical energy greater than a sum of (1) a first amount of electrical energy needed to apply, to first plasma generator 1, a breakdown voltage sufficient to induce breakdown between first electrodes of first plasma generator 1, resulting in formation of plasma between the first electrodes, and (2) a second amount of electrical energy needed to apply, to second plasma generator 2, a breakdown voltage sufficient to induce breakdown between second electrodes of second plasma generator 2, resulting in formation of plasma between the second electrodes.

In some embodiments, the plasma generation circuitry may be further configured to, after terminating application of electrical energy to a plasma generator, apply additional electrical energy to that plasma generator, such as using at least some of the electrical energy remaining stored in the energy storage device. For example, the electrical energy applied prior to termination may be sufficient to propagate plasma formed between the electrodes of the given plasma generator toward a distal tip of the electrodes and the additional electrical energy may be sufficient to further propagate the plasma toward the distal tip (e.g., without total recombination of the plasma in between applications of electrical energy).

In some embodiments, the plasma generation circuitry may be further configured to, after terminating application of electrical energy to a first plasma generator, apply electrical energy to a second plasma generator using electrical energy stored in the energy storage device. For example, following termination of a first pulse of electrical energy to first plasma generator 1, a second pulse of electrical energy may be applied to plasma generator 2. For instance, electrical energy may be applied to the first plasma generator 1 and the second plasma generator 2 at least partially at different times, with the second pulse and the first pulse not overlapping at all in time, and/or at least partially at the same time, with the second pulse overlapping at least in part in time with application of a third pulse to the first plasma generator 1.

In some embodiments, the circuitry of the plasma generation system may be further configured to apply the breakdown voltage to the electrodes of each of the plasma generators. For example, the plasma generation circuitry shown in FIG. 3A may further include breakdown circuitry (see, e.g., FIG. 8) configured to apply, to each of the plasma generators, a breakdown voltage sufficient to induce breakdown between the electrodes, resulting in formation of plasma between the electrodes. It should be appreciated, however, that the breakdown circuitry may apply electrical energy with or without using the energy storage device and/or multiplexing circuitry.

In some embodiments, an amount of electrical energy delivered to each plasma generator may include breakdown energy sufficient to induce the breakdown between electrodes of the plasma generator and follow-on energy sufficient to prevent total recombination of the plasma between the electrodes. For example, at least the follow-on energy may be supplied from the energy storage device via the illustrated multiplexing circuitry.

In the illustrated embodiment, the energy storage device is shown coupled to a power supply, which may be configured to recharge the energy storage device. For example, recharging may be performed when the energy storage device is depleted and/or between ignition cycles, and/or may be performed consistently during operation by providing a trickle charge to the energy storage device.

FIG. 3B illustrates an example plasma generation system including plasma generation circuitry having a shared circuit component coupled to a respective transformer for each plasma generator, according to some embodiments.

In some embodiments, the plasma generation system shown in FIG. 3B may be configured as described herein including in connection with FIG. 2 such as including a plurality of plasma generators and plasma generation circuitry that includes a shared circuit component. In the illustrated embodiment, the plasma generation circuitry further includes a transformer for each plasma generator with a secondary coil of the transformer coupled in the energy flow path to the plasma generator from the shared circuit component. For instance, the shared circuit component may include a shared switching element, a shared energy storage device (e.g., including a shared capacitor), and/or a shared inductance.

According to an aspect of the present disclosure, a plasma generation system such as shown in FIG. 3B may include a plurality of plasma generators, a plurality of energy flow paths to the plasma generators, respectively, the energy flow paths sharing a shared circuit component, such as shown in FIG. 3B. For example, the shared circuit component may be configured as described herein including in connection with FIGS. 2 and 3A. In the illustrated embodiment, the plasma generation system further includes a plurality of transformers, for each of the plasma generators, respectively, each transformer including a primary coil and a secondary coil. For example, the primary coil may be configured to trigger breakdown between the electrodes of its associated plasma generator, resulting in formation of plasma between the electrodes, and the secondary coil may be configured to receive electrical energy for applying to the plasma generator along the energy flow path to the plasma generator and via the shared circuit component. For instance, the secondary coil may be configured to apply that energy following breakdown (e.g., where breakdown is triggered via the primary coil). By having follow-on or supplemental energy flow paths that extend through a shared circuit component and then to the respective plasma generators via separate secondary coils, a single source of energy storage can be used with portions of the stored energy controllably delivered to the different plasma generators, and this can be done in at least some embodiments without having to recharge the energy storage device in between each individual supply of energy to each individual plasma generator. Thus, for example, electrical energy can be distributed from a single storage capacitor (or capacitor bank) to multiple plasma generators in a manner that does not involve substantially or fully depleting the storage capacitor(s) such that they may then be recharged after all plasma generators have been satisfied for a particular plasma event, and before the next iteration of plasma events. In other embodiments, the plasma generation circuitry may be configured to permit substantial or full depletion of the energy storage device each time it supplies electrical energy to any one of the plasma generators and to recharge prior to supplying the next plasma generator.

According to various embodiments, electrical energy received at the secondary coil and applied to the plasma generator may be sufficient to prevent total recombination of plasma formed between the electrodes of the plasma generator, and/or sufficient to propagate the plasma toward a distal tip of the at least two electrodes, and/or sufficient to move a point of discharge of electrical energy to and/or from the at least two electrodes, and/or sufficient to produce a Lorentz force component along the at least two electrodes.

In some embodiments, the plasma generation circuitry shown in FIG. 3B may be further configured to apply a breakdown voltage to the electrodes of each plasma generator, such as by applying electrical energy to the primary coil of each transformer to place the breakdown voltage across the secondary coil. In other embodiments, the breakdown voltage may be applied (e.g., to the primary coil) by other circuitry (e.g., that does not share the shared circuit component). In some embodiments, breakdown may cause electrical energy to flow through the secondary coil to the plasma generator (e.g., via the shared circuit component) at least initially, even before (e.g., controlled) application of any electrical energy following breakdown.

In some embodiments, the transformer for each plasma generator may include a saturable core, such as described further herein including in connection with FIG. 8.

FIG. 4 illustrates an example plasma generation system including a cross-section of at least two electrodes and circuitry configured to apply electrical energy to the electrode(s), according to some embodiments.

In some embodiments, the illustrated plasma generator and plasma generation circuitry may be configured as described herein in connection with FIGS. 1-3B, such as with the first plasma generator 1 and the second plasma generator 2 being configured as described herein for the plasma generator shown in FIG. 4.

As shown in FIG. 4, a plasma generator is disposed at least in part in an environment. For example, in FIG. 4, the plasma generator includes at least two electrodes (e.g., additional electrodes may be present though not shown). In some embodiments, the environment may be an ignition environment in which it is desired to form and/or propagate plasma to ignite an air-fuel mixture. In the illustrated embodiment, at least distal tips of the electrodes are proximate to the environment, though in other cases, more of the electrodes may be exposed to the environment.

In some embodiments, a plasma generation system may be configured to apply across at least two electrodes, a breakdown voltage sufficient to induce breakdown between the electrode(s), resulting in formation of plasma between the electrode(s). For example, as shown in FIG. 4, a first electrode 1 and a second electrode 2 may receive the breakdown voltage thereacross, such as by having the breakdown voltage applied to one electrode and a reference voltage (e.g., ground) applied to the other electrode. For instance, the breakdown voltage may be sufficient that a dielectric (e.g., air gap) between the electrodes may breakdown and form plasma that provides a conductive path between the electrodes through which current may flow.

In some embodiments, breakdown between the electrode(s) may result in formation of plasma in an initiation region. For example, in FIG. 4, a plasma kernel P is shown formed between the electrodes 1 and 2 between a first point 1 and a second point 2. For instance, the first point 1 and the second point 2 may form the initiation region with initial plasma formation therebetween. In some embodiments, the initiation region may be a region at which electrical discharge between the electrodes through the broken-down dielectric begins, thereby providing a conductive path within that region through the plasma where the dielectric broke down. For example, the initiation region may be where, prior to breakdown (and/or prior to formation of plasma and/or prior to system-induced ionization), impedance is lowest between the electrodes. In the illustrated embodiment, the electrodes 1 and 2 are separated by an isolator, which may include ceramic, such that a surface of the isolator provides a lowest impedance path between the electrodes 1 and 2. For instance, the initiation region may be proximate the surface of the isolator. In some embodiments, the surface of the isolator may be treated (e.g., with a conductive agent that induces semiconductive behavior) to further reduce the impedance proximate the surface, as this may reduce the breakdown voltage needed to initiate plasma. In some embodiments that are configured to propagate plasma along a length of the electrodes, an initiation region may be a first location from which the plasma is propagated (e.g., terminating at least at the distal tips of the electrodes).

It should be appreciated that the electrodes may not be separated along their entire lengths by any given isolator and/or alternative or additional material (e.g., including a gap) may be between the electrodes along at least a portion of their length, such as due to manufacturing tolerance.

It should be appreciated that multiple initiation regions may be present in a plasma generator as formed and/or configured for use. For example, where electrodes are manufactured with portions projecting towards one another, such portions may provide a lowest impedance path between the electrodes prior to at least some applications of the breakdown voltage. In the same example, portions projecting towards one another may be destroyed after several applications of the breakdown voltage such that other points along the electrodes have a lowest impedance path between the electrodes. Any or each of such points may be considered an initiation region in which the electrodes are configured to initially form plasma following application of a breakdown voltage, even before destruction of some portions that form an initiation region.

According to various embodiments, the electrode(s) may have any suitable configuration. For example, electrodes may be present in a coaxial configuration. In the same or another example, more than two electrodes may be present, such as with some of the electrodes configured as anodes (e.g., receiving the breakdown voltage) and some of the electrodes configured as cathodes (e.g., receiving a reference voltage, or vice versa). For instance, in a rail configuration, multiple electrodes may be spaced from one another and/or from another electrode (e.g., a central electrode), such as with one electrode configured as an inner electrode and other electrodes configured as outer electrodes.

In some embodiments, a plasma generation system such as shown in FIG. 4 may be configured to apply to the electrode(s), after applying the breakdown voltage and before total recombination of the plasma, follow-on electrical energy resulting in a follow-on current through the plasma. For example, following breakdown and without application of follow-on energy, the plasma may naturally recombine as time goes on, which results in a rapid reduction in the amount of current flowing through the plasma. In this example, follow-on current may flow through the plasma thereby sustaining the plasma and maintaining the conductive path therethrough. Moreover, as described further herein, the follow-on current may propagate the plasma along the electrode(s), such as by producing a Lorentz force component along the electrode(s).

In some embodiments, electrical energy applied to the electrodes may be sufficient to propagate the plasma along a length of the electrode(s). For example, in a traveling spark igniter configuration, current flowing through the electrodes 1 and 2 may produce a Lorentz force component along a length of the electrode(s) 1 and/or 2 that pushes the plasma along the length of the electrodes 1 and 2 (e.g., along the length direction DL). For instance, following application of a pulse of current, the plasma kernel P shown in FIG. 4 may move in the length direction DL towards a distal tip of the electrode(s) 1 and 2. In some embodiments, applying a sequence of multiple pulses of follow-on current prior to total recombination of the plasma may sustain propagation of the plasma kernel P with each pulse beyond any initial propagation that may be induced by application of the breakdown voltage.

In some embodiments, electrical energy applied to the electrodes may be sufficient to move a point at which electrical energy is discharged from the electrodes. For example, as shown in FIG. 4, the first electrode 1 further has a third point 3 along the electrode(s) and the second electrode 2 further has a fourth point 4 along the electrode(s). For instance, electrical energy applied to the electrodes 1 and 2 may cause (e.g., using a Lorentz force component along the electrodes 1 and 2) the plasma between the electrodes 1 and 2 to move from being between the first point 1 and the second point 2 to being between the third point 3 and the fourth point 4, such that points of electrical energy discharge (e.g., into the plasma) move from the first point 1 to the third point 3 and/or from the second point 2 to the fourth point 4. In some embodiments, a Lorentz force may result from a magnetic field that is based on current flowing through the electrodes 1 and 2 as it acts on current flowing through the plasma formed between the electrodes 1 and 2. It should be appreciated that the amount of Lorentz force generated may depend on characteristics of the environment, the electrodes (e.g., materials thereof), the medium in which plasma is formed (e.g., isolator and/or dielectric gap), and the amount of applied electrical energy, and the directionality of the Lorentz force may further depend on the electrode configuration (e.g., relative directions in which current flows in the plasma generator). In some embodiments, a plasma generation system such as shown in FIG. 4 may be further configured to apply, to the electrode(s), follow-on energy flowing through the plasma sufficient to propagate the plasma and then to further propagate the plasma. For example, the follow-on current (e.g., flowing between the first point 1 and the second point 2) may include a first pulse of current and the second follow-on current may include a second pulse of current applied at a time later than the first pulse of current. For instance, the second follow-on current may flow through the plasma from the third point 3 to the fourth point 4. In the illustrated embodiment, the third point 3 and the fourth point 4 are spaced along a length (e.g., in the length direction DL) of the electrode(s) from the first point 1 and the second point 2. It should be appreciated that plasma may be propagated as far as and even beyond the distal tips of the electrodes, the extent of propagation being limited based on available energy, thermal, and pressure conditions in the environment. For instance, high pressure and/or high temperature environments may limit the amount of electrical energy that may be usefully discharged (e.g., without vaporizing the electrodes) and achieve plasma propagation (e.g., against the high resistance to motion of a dense environment), whereas lower pressure environments may permit propagation of a few inches or more.

In some embodiments, in the plasma generation systems described herein including multiple plasma generators, breakdown and/or application of follow-on energy may be performed at the same time and/or in sequence depending on the desired timing and/or location(s) of the formed plasma.

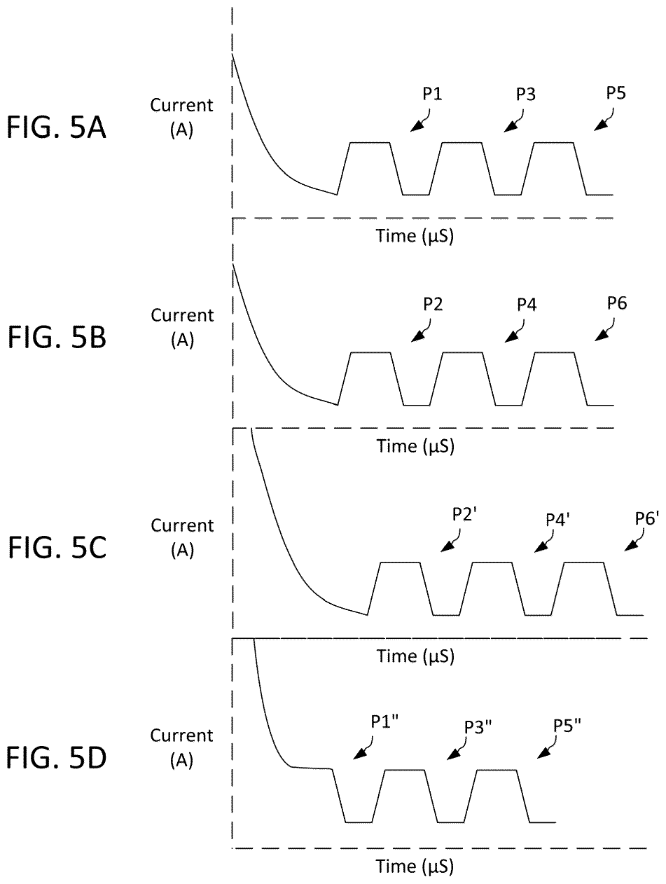

FIG. 5A illustrates example application of electrical energy to a first plasma generator of the system of FIG. 1, according to some embodiments. It should be appreciated that example application of electrical energy shown in the examples of FIGS. 5A, 5B, and 5C may occur in any plasma generation system described herein, including in connection with FIGS. 1-4 and 6-8.

In the illustrated embodiment of FIG. 5A, breakdown energy may be applied to the first plasma generator at a voltage sufficient to induce breakdown shortly before the illustrated portion begins, resulting in formation of plasma.

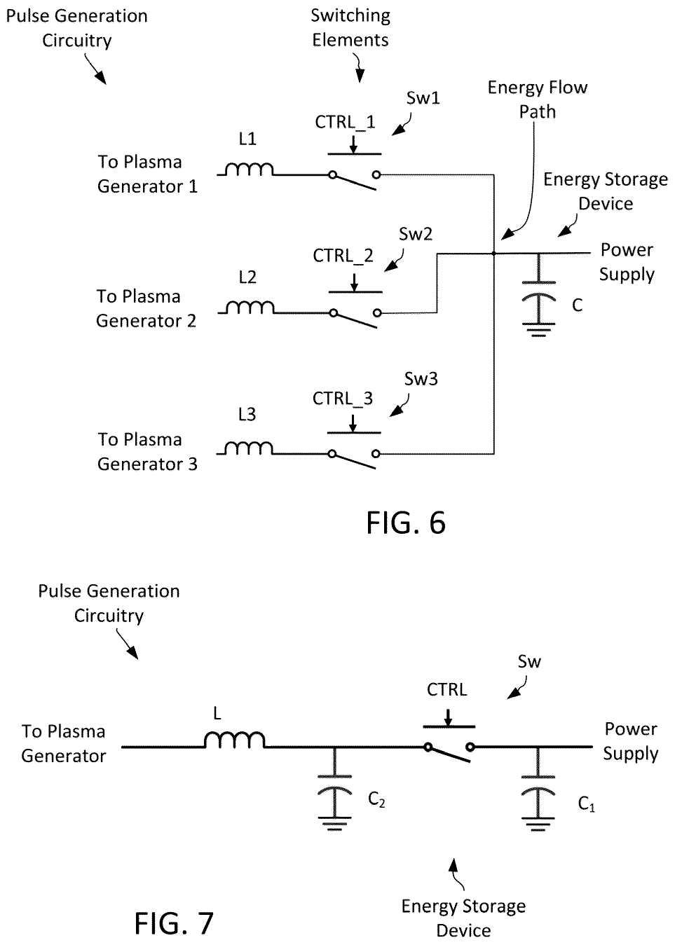

As shown in FIG. 5A, breakdown may be followed by a decline in current through the plasma, such as due to at least partial plasma recombination. In the illustrated embodiment, a sequence of at least three pulses of follow-on current are applied (e.g., additional pulses may be applied after the illustrated timeframe), including pulses P1, P3, and P5. For example, the follow-on current pulses shown in FIG. 5A may be applied using circuitry shown in FIGS. 6-8, though other circuitry configurations could be used. It should be appreciated that fewer pulses than illustrated may be applied, depending on the embodiment.

In some embodiments, applying follow-on energy to a plasma generator may include altering a rate of current decay through the plasma with respect to current decay following breakdown without the follow-on current. For example, as shown in FIG. 5A, the current decay following breakdown is altered by the three pulses of follow-on current. In some embodiments, altering the rate of current decay may include actively applying follow-on current to produce a higher current than would be flowing through the plasma following breakdown without applying the follow-on current. For example, in FIG. 5A, current flowing through the plasma is higher at each illustrated pulse than the current would be according to the decay curve that precedes the pulses. For instance, application of follow-on current may include using at least one active circuit element, such as a switching element.

In some embodiments, applying follow-on energy may include applying, to the electrode(s), at least two pulses of current. For example, in FIG. 5A, each pulse is shown having a peak current that is the same for each pulse, though need not be. It should be appreciated that while square pulses (e.g., trapezoidal pulses due to nonzero rise and fall times in a practical implementation) are shown in FIG. 5A, other pulse shapes may be used such as triangle and/or sinusoidal pulses.

In some embodiments, applying follow-on and/or a pulse of electrical energy may be before a next application of the breakdown voltage to the electrode(s). For example, as shown in FIG. 5A, the current through the plasma does not rise to its post-breakdown decay level before application of the illustrated pulses. It should be appreciated that some at least partial recombination of the plasma may occur prior to at least some applied follow-on current, which may result in a breakdown voltage lower than the applied breakdown voltage being applied (e.g., using a voltage across the secondary coil of the transformer, which may become at least partially unsaturated) before at least some of the applied follow-on current.

FIG. 5B illustrates example application of electrical energy to a second plasma generator of the system of FIG. 1 at the same time as the first plasma generator, according to some embodiments.

In the illustrated embodiment of FIG. 5B, breakdown energy may be applied to the second plasma generator substantially at the same time as the first plasma generator of FIG. 5A, resulting in breakdown occurring at substantially the same time. Also shown in FIG. 5B, pulses P2, P4, and P6 are applied at substantially the same time as pulses P1, P3, and P5 in FIG. 5A. However, that need not be the case (see FIG. 5C below).

FIG. 5C illustrates an alternative example application of electrical energy to the second plasma generator of FIG. 5B at least partially at the same time as the first plasma generator, according to some embodiments.

In the illustrated embodiment of FIG. 5C, breakdown energy may be applied to the second plasma generator after breakdown energy is applied to the first plasma generator, resulting in breakdown occurring later than in the first plasma generator. Also shown in FIG. 5C, pulses P2′, P4′, and P6′ occur following respective pulses P1, P3, and P5 in the first plasma generator. It should be appreciated that some plasma generator configurations may permit application of breakdown energy at the same time in multiple plasma generators and application of follow-on energy at different times in the respective plasma generators and/or application of breakdown energy at different times in multiple plasma generators and application of follow-on energy at the same time in the respective plasma generators, as aspects described herein are not so limited.

FIG. 5D illustrates an alternative example application of electrical energy to the first plasma generator of FIG. 5A, according to some embodiments.

As described above including in connection with FIGS. 5A-5C, applying follow-on energy to a plasma generator may include altering a rate of current decay through the plasma with respect to current decay following breakdown without the follow-on current. For example, as shown in FIG. 5D, the current decay following breakdown is altered by three pulses of follow-on current P1″, P3″, and P5″. In the illustrated embodiment, the rate of current decay may be altered by actively applying follow-on current to produce a higher current than would be flowing through the plasma following breakdown without applying the follow-on current. For example, in FIG. 5D, current flowing through the plasma is higher at the first pulse P1″ than the current would be according to the decay curve that precedes the first pulse P1″. And, in contrast to the examples of FIGS. 5A-5C, the decay curve is no higher than the first pulse P1″ when the first pulse P1″ begins. For instance, the first pulse P1″ may alter the rate of current decay by reducing the rate of current decay to be lower than without applying the first pulse P1″.

FIG. 6 illustrates example plasma generation circuitry including switching elements coupled between an energy storage device and multiple plasma generators, respectively, according to some embodiments.

In some embodiments, the plasma generation circuitry shown in FIG. 6 may be configured as described herein including in connection with FIGS. 2, 3A, and 3B, such as being coupled to a plurality of plasma generators and including a shared circuit component. In the illustrated embodiment, the shared circuit component includes an energy storage device, such as shown in FIG. 3A. And, in the illustrated embodiment, an inductance is coupled in each path from the shared circuit component to the respective plasma generator, which may include the secondary coil of a transformer such as shown in FIG. 3B, but is not limited thereto.

In some embodiments, an energy storage device 614 may include a capacitor configured to store electrical energy to be delivered to each of a plurality of plasma generators. For example, in FIG. 6, the energy storage device includes a capacitor C, which may be a single capacitor either alone or in combination with another capacitor or other capacitors of the energy storage device. Alternatively or additionally, the capacitor C may represent a capacitance formed using multiple capacitors and/or other circuit elements interconnected so as to provide capacitance for an energy storage device.

In some embodiments, the plasma generation circuitry shown in FIG. 6 may include paths to each plasma generator that are switchable to terminate delivery of electrical energy to the plasma generators (e.g., with the energy storage device storing at least some additional electrical energy after termination of delivery). For example, as shown in FIG. 6, the plasma generation circuitry includes a first switching element Sw1 coupled in a first path that includes the energy storage device and a first plasma generator, which may be configured to control application of electrical energy from the energy storage device to the first plasma generator. For instance, the first switching element Sw1 may be configured to be turned on to draw electrical energy from the energy storage device to the first plasma generator, and/or may be configured to be turned off while current is flowing through it, such that the first switching element Sw1 may be opened before depletion of electrical energy stored in the energy storage device.

In the illustrated embodiment, the plasma generation circuitry includes, for each of the plasma generators, a respective switching element Sw1, Sw2, Sw3 coupled in a respective path that includes the plasma generator and the energy storage device, which may be configured to terminate delivery of electrical energy from the energy storage device to the electrodes of the respective plasma generator with at least some additional electrical energy remaining in the energy storage device. According to various embodiments, the switching elements Sw1, Sw2, Sw3 may include isolated gate bipolar transistors (IGBTs), metal-oxide field effect transistors (MOSFETs), and/or thyristors such as MOS-controlled thyristors (MCTs). These devices enable the plasma generation circuitry to interrupt the current through the switch device. For applications involving a substantial or complete depletion of energy from the energy storage device, other latching or non-interruptible switch devices may be used, such as a silicon-controlled rectifier (SCR) or other such devices known to those skilled in the art.

In some embodiments, the shared energy flow path from the energy storage device up to and/or including the switching elements Sw1, Sw2, and Sw3 may form at least a portion of a controlled energy discharge path such as described herein including in connection with FIG. 1. For example, each switching element Sw1, Sw2, and Sw3 may be in a respective portion of the controlled energy discharge path with its associated plasma generator.

In some embodiments, the plasma generation circuitry may be further configured to, after terminating delivery of electrical energy to at least one first plasma generator, deliver, to at least one second plasma generator of the plasma generators, using at least some of the additional electrical energy stored in the energy storage device, electrical energy sufficient to prevent total recombination of plasma formed between electrodes of the second plasma generator(s). For example, in FIG. 6, after turning off switching element Sw1 to terminate delivery of electrical energy to the first plasma generator 1, switching element Sw2 (and/or switching element Sw3) may be turned on to deliver electrical energy to the second plasma generator 2 (and/or a third plasma generator). For instance, a first pulse (e.g., P1 in FIG. 5A) of electrical energy (e.g., current) may terminate by turning off switching element Sw1 and a second pulse (e.g., P4 in FIG. 5B or P2′ in FIG. 5C) may be delivered using switching element Sw2. According to various embodiments, the same or different amounts of electrical energy may be delivered to the respective plasma generators 1 and 2.

In some embodiments, the plasma generation circuitry may be alternatively or additionally configured to, after terminating application of electrical energy to a plasma generator, apply at least some of the additional stored electrical energy remaining in the energy storage device to at least the same plasma generator. For example, after termination of application of a first pulse of current (e.g., P1 in FIG. 5A) to the first plasma generator 1 by turning off switching element Sw1, switching element Sw1 may be turned on again to apply a second pulse of current to the first plasma generator 1 (e.g., P3 in FIG. 5A). For instance, the second pulse of current may be sufficient to further propagate plasma that was initiated and/or propagated by the first pulse of current. According to various embodiments, the multiplexing circuitry may be configured to terminate application of electrical energy and subsequently apply remaining stored electrical energy to some or all of the plasma generators, whether one, multiple, and/or all at a same time. As one example, switching element Sw1 may be turned on to apply a first pulse of electrical energy (e.g., P1 in FIG. 5A) to a first plasma generator and then turned off to terminate the first pulse of electrical energy, at least partially during the same time as switching element Sw2 may be turned on to apply a second pulse of electrical energy (e.g., P2 in FIG. 5B or P2′ in FIG. 5C) to a second plasma generator and then turned off to terminate the second pulse of electrical energy, subsequent to which switching element Sw1 may be turned on again to apply a third pulse of electrical energy (e.g., P3 in FIG. 5A) to the first plasma generator.

In the illustrated embodiment, the switching elements Sw1, Sw2, and Sw3 are shown in FIG. 6 configured to receive respective control signals CTRL_1, CTRL_2, and CTRL_3, which may be provided from a controller, and/or may be preset according to an operating configuration. For example, the controller may be configured to control application of electrical energy to the respective pulse generators and may or may not incorporate active current control feedback (see, e.g., FIG. 8).

In some embodiments, the plasma generation circuitry may further include an inductance in the path to each plasma generator. For example, in FIG. 6, the plasma generation circuitry includes, for each of the plasma generators, an inductance coupled between the energy storage device and the plasma generator. For instance, the inductance may be configured to apply a large voltage to the plasma generator prior to being saturated, and while at least partially saturated, may provide a low impedance path for delivering electrical energy from the energy storage device to the plasma generator. In the illustrated embodiment, for each of the plasma generators, a path including the plasma generator, the inductance, and the energy storage device is switchable (e.g., using the respective switching element) to terminate delivery of electrical energy from the energy storage device to the plasma generator via the inductance (e.g., with at least some additional electrical energy remaining in the energy storage device).

It should be appreciated that the plasma generation circuitry shown in FIG. 6 may further include other circuitry, such as breakdown circuitry for applying a breakdown voltage to the plasma generators, such as shown in FIG. 8.

FIG. 7 illustrates example plasma generation circuitry including an energy storage device having multiple capacitive portions, according to some embodiments.

In the illustrated embodiment, an energy storage device is shown including a first capacitance C₁ and a second capacitance C₂ with a switch Sw coupled between the first capacitance C₁ and the second capacitance C₂ and an inductance L coupled in a path that includes the energy storage device and a plasma generator.

In some embodiments, a shared capacitance of an energy storage device may be configured to controllably apply electrical energy to multiple plasma generators. For example, in FIG. 7, the first capacitance C₁ may be shared among multiple plasma generators. For instance, the first capacitance C₁ may be configured to store at least (e.g., more than) sufficient electrical energy to apply a breakdown voltage to each plasma generator collectively (e.g., one at a time and/or at least partially overlapping in time. According to various embodiments, a switch Sw and a second capacitance C₂ may be included for each plasma generator.

In some embodiments, switch Sw may be configured to controllably apply electrical energy to multiple plasma generators. For example, prior to breakdown, the switch Sw may be configured to close and provide electrical energy to the second capacitance C₂ from the first capacitance C₁, at which point switch Sw may open (e.g., based on a control signal CTRL). For instance, the second capacitance C₂ may have a smaller capacitance than the first capacitance C₁ such that the second capacitance C₂ may fill using electrical energy from the first capacitance C₁. In this example, at breakdown, the second capacitance C₂ may be configured to apply electrical energy to the plasma generator via the inductance L. For instance, the inductance L may be configured to saturate as a result of breakdown (e.g., as a secondary coil triggered by a primary coil), such that electrical energy stored in the second capacitance C₂ may discharge to the plasma generator via the inductance (e.g., without needing to close a switch in a path that includes the inductance L, the second capacitance C₂ and the plasma generator).

In some embodiments, the switch Sw may be configured to controllably apply electrical energy to the plasma generator following breakdown. For example, the second capacitance C₂ may be configured to fully deplete its electrical energy into the plasma generator, after which the switch Sw may be configured to close and apply follow-on electrical energy (e.g., as described herein) to the plasma generator. For instance, the second capacitance C₂ may be small enough and/or the switch Sw may be closed early enough that follow-on electrical energy may be applied to the plasma generator prior to total recombination of plasma that formed during breakdown. In this example, application of electrical energy to the plasma generator may terminate (e.g., upon depletion of the second capacitance C₂) with at least some electrical energy remaining stored in the first capacitance C₁, which may be applied following the termination.

As another example, the second capacitance C₂ may be configured to only partially deplete its electrical energy into the plasma generator, such as where a path that includes the second capacitance C₂ and the plasma generator is switchable (e.g., using a further switching element, not shown) to terminate application of electrical energy from the second capacitance C₂). In this example, application of electrical energy to the plasma generator may terminate with at least some electrical energy remaining in the second capacitance C₂. In some embodiments, switch Sw may be further configured to control application of electrical energy to individual ones of multiple plasma generators. For example, the second capacitance C₂ may be shared among multiple plasma generators with a further switching element (e.g., not shown) for each plasma generator configured to control application of electrical energy from the second capacitance C₂ to that plasma generator (e.g., as in FIG. 6). For instance, the further switching elements may be configured to select the respective plasma generators to receive the electrical energy from the second capacitance C₂. Alternatively or additionally, a second capacitance C₂ and a switch Sw may be included for each plasma generator, with the switch Sw for each plasma generator configured to control transfer of electrical energy from the shared first capacitance C₁ to the respective second capacitance C₂.

It should be appreciated that the configuration of FIG. 7 may be implemented using shared inductance in place of and/or in addition to shared capacitance, such as to store magnetic energy for controllably applying to one or more plasma generators. For example, a first (e.g., relatively large) inductance may be coupled in a loop having magnetic energy stored in the inductance, resulting in a high current flowing in the inductance. In this example, a switching element may be configured to couple current from the first inductance to a second (e.g., smaller) inductance, such as to provide magnetic energy from the first inductance to the second inductance for controllably applying electrical energy from the second inductance to a plasma generator. Other aspects of FIG. 7 may be similarly implemented in such a configuration.

FIG. 8 illustrates example plasma generation circuitry including breakdown circuitry and current control circuitry that is switchable to draw electrical energy from an energy storage device to a plasma generator.

In some embodiments, the plasma generation circuitry shown in FIG. 8 may be implemented as described herein including in connection with FIGS. 1-4 and 6-7. For example, in the illustrated embodiment, an energy storage device may be shared among multiple plasma generators (e.g., each having an associated instance of the plasma generation circuitry shown in FIG. 8), such as described herein including in connection with FIGS. 3A-7.

In FIG. 8, the plasma generation circuitry 800 includes breakdown circuitry 802, which may be configured to apply a breakdown voltage to electrodes of a plasma generator using energy stored in an energy storage device (e.g., other than the energy storage device used for applying follow-on energy but not limited thereto). For example, in FIG. 8, the breakdown circuitry 802 includes a breakdown capacitance 804 coupled to a breakdown switch 806 via a primary coil 816a of a transformer 816 (e.g., as the primary coil of one of the transformers in FIG. 3B). For instance, upon closing of the breakdown switch 806, energy stored in the breakdown capacitance 804 may pass through the primary coil 816a and thereby draw current through a secondary coil 816b of the transformer to the plasma generator, which may produce a voltage across the secondary coil 816b sufficient to induce breakdown (e.g., due to a turns ratio of the transformer and the rate at which current is changing at least in the secondary coil 816b). In the illustrated embodiment, a pulse generator 830 is further included to produce a breakdown signal applied to the breakdown switch 806 to controllably initiate breakdown.

In the illustrated embodiment, breakdown capacitance 804 may be charged via a breakdown diode 808 and a charging resistor 810 from a power supply 812. For example, after breakdown, the breakdown switch 806 may be opened to permit recharging of the breakdown capacitance 804 without the charging current passing through the transformer to the switch 806.

In some embodiments, applying a breakdown voltage to the electrode(s) of a plasma generator may include applying the breakdown voltage from an energy storage device to the electrode(s) via a transformer. For example, as shown in FIG. 8, the transformer further couples another energy storage device (e.g., see FIG. 6) to the plasma generator 840 on the secondary side. In some embodiments, upon closing of the breakdown switch 806, current may flow from the energy storage device through the secondary coil 816b of the transformer 816 to the plasma generator 840. In the illustrated embodiment, application of breakdown energy to the primary coil 816a is shown using a different energy storage device 804 than application of breakdown energy to the secondary coil 816b, though a shared energy storage device may be used to apply energy to both the primary coil 816a and the secondary coil 816b in other embodiments, as embodiments described herein are not so limited.

Similarly, in some embodiments, applying follow-on electrical energy to the electrode(s) may include applying the follow-on electrical energy from the energy storage device to the electrode(s) via the transformer 816. For example, after breakdown, additional current may flow from the energy storage device to the plasma generator via the secondary coil 816b of the transformer, which is the same path as the breakdown voltage in the illustrated embodiment. In other embodiments, separate energy storage devices may be used for application of breakdown voltage and follow-on energy, such as with energy storage for breakdown being dedicated to one (or more) plasma generators and energy storage for follow-on energy being shared among all plasma generators.

In some embodiments, the transformer 816 may have a saturable core. For example, the transformer 816 may have a low turns ratio (e.g., 37:1) to produce a relatively low breakdown voltage and saturate upon application of sufficient current through the secondary coil 816b. For instance, a transformer core may be at least partially saturated when the secondary coil 816b inductance becomes significantly less inductive due to the core (e.g., ferromagnetic material about which the secondary coil is wound) taking on behavior of air, and/or the secondary coil 816 becoming substantially decoupled from the primary coil 816a.

In some embodiments, the (e.g., saturable) core of the transformer 816 may be saturated by application of the breakdown voltage and may remain at least partially saturated at least through (e.g., controlled) application of electrical energy following breakdown. For example, by keeping at least partial saturation of the transformer 816 at least through application of follow-on electrical energy, current applied to the secondary coil 816b during at least partial saturation may encounter a relatively low inductance and produce a low voltage drop across the secondary coil 816b while passing through to the plasma generator 840 to flow through the plasma.

In some embodiments, applying the breakdown voltage and/or applying the follow-on current may include closing a switching element coupled in a path from the plasma generator that includes the energy storage device and the transformer. For example, in FIG. 8, the plasma generation circuitry 800 further includes a switch 818 coupled in a path from the plasma generator 840 through the secondary coil 816b of the transformer 816 to the energy storage device and further to ground via the switch 818. In other embodiments, the switch 818 may be coupled between the plasma generator 840 and the secondary coil 816b of the transformer 816, and/or between the secondary coil 816b of the transformer 816 and the energy storage device such as in the configuration of FIG. 6. For instance, the secondary coil 816b of the transformer 816 in FIG. 8 may be and/or include an inductance of the plasma generation circuitry of FIG. 6 coupled between the energy storage device and the plasma generator 840, with the switch 818 being configured as at least part of a switching element (e.g., Sw1). While a single switch 818 is shown, it should be appreciated that multiple switches may be included in a switching element, such as multiple series and/or parallel connected switches. According to various embodiments, a switching element may include an isolated gate bipolar transistor (IGBT), a thyristor such as a MOS-controlled thyristor (MCT).

In the illustrated embodiment, a diode 820 is further coupled to a point between the energy storage device and the secondary coil 816b of the transformer 816, such as to create a reference voltage point (e.g., close to 1 V above ground in FIG. 8) between the energy storage device and the secondary coil 816b while the switch 818 is closed.

In some embodiments, the plasma generation circuitry may be configured to actively control application of follow-on energy to the plasma generator. For example, in FIG. 8, the plasma generation circuitry 800 further includes current control circuitry 822. In the illustrated embodiment, the current control circuitry 822 includes a feedback loop incorporating feedback from a current sensor 826 into a feedback signal 824. For instance, the feedback loop may be configured to regulate an amount of current flowing through the secondary coil 816b (e.g., corresponding to current flowing through the plasma) by comparing a sensed amount of current flowing through the switch 818 to a threshold current level (e.g., set by a control voltage VCTRL), and enable a secondary side signal 834 to turn on the switch 818 using a control signal CTRL_F based on the sensed amount of current. In the illustrated embodiment, pulse shaping 828 is also applied, such as may be used to control a rise time and/or fall time of a pulse of follow-on current.

It should be appreciated that other plasma generation circuitry configurations may be used depending on the application. For example, where a sufficiently low breakdown voltage may be used (e.g., where a treated ceramic isolator surface provides for a very low breakdown voltage), the breakdown voltage and/or follow-on current may be delivered directly to the plasma generator from an energy storage device, such as without first passing through an inductance. For instance, an energy storage device may be coupled directly to a plasma generator by a switching element.

FIG. 9 depicts another example 900 of a plasma generation system that utilizes shared circuitry to operate two separate plasma generators. In this example embodiment, the plasma generation system more specifically comprises an ignition system such as may be used in aerospace (aviation or space) applications to ignite a fuel for purposes of vehicle propulsion. Thus, the plasma generation circuitry comprises an exciter and the plasma generators themselves comprises igniters of the ignition system.

Ignition system 900 includes two channels; that is, two different exciters each associated with one of the two igniters 918, 928. In general, ignition system 900 includes a separate circuit (Channel A and Channel B) that provides an initial breakdown voltage and current suitable to generate a plasma at each of the respective associated igniters 918, 928, and includes a single circuit (Shared Circuitry) that provides one or more subsequent pulses of electrical energy used to sustain the plasma at the igniters. Ignition system 900 also includes a control circuit that generates the control signals used by Channels A and B and the Shared Circuitry to initiate the breakdown and subsequent pulse(s). Control circuit 960 includes the logic and timing required to produce alternating plasma discharge events between the two Channels A and B, and the construction and operation of the control circuit 960 will be apparent to those skilled in the art. Thus, Channel A igniter 918 is fired and the plasma sustained using the Shared Circuitry until the plasma event concludes, followed by Channel B igniter 928 being fired and the plasma sustained using the Shared Circuitry until that plasma event concludes, and the sequence repeats.

To carry this out, ignition system 900 includes a power supply 902 that provides a HV_MAIN supply of suitable voltage (e.g., 200-1000v) via a diode 904. This HV_MAIN is used to charge the energy storage devices used in Channels A and B and the Shared Circuitry (i.e., storage capacitors 912, 922, 942, and 944). For this purpose, power supply 902 can be implemented by a shuntable (short circuit protected) supply that continuously charges the storage capacitors when the control circuit outputs are all off (i.e., all transistors 912, 922, 946, 948 are switched OFF). Capacitor 912 of Channel A is charged by this HV_MAIN power via diode 910. Upon a positive voltage being output on CTRL_1, the MOSFET 916, acting as a switch, turns ON thereby causing the capacitor 912 to discharge through the primary of step-up transformer 914. This produces a large amplitude voltage across the secondary sufficient to initiate an arc across igniter 918. With the relative primary and secondary winding directions shown (dot at the top of each winding), the secondary current will flow through the igniter 918 and resistors 932, 934.

In an alternative embodiment of that shown in FIG. 9, the primary and secondary windings can be wound in opposite directions—for example, with the secondary winding dot at the bottom, such that the secondary current will flow in the opposite direction—i.e., through diode 130 and the igniter 918. In this alternative embodiment, the resistors 932, 934 can be eliminated.

Transformers 914 and 924 can be constructed in the same manner as each other and as described above in connection with FIG. 8 including a turns ratio that generates sufficient voltage across the secondary to initiate breakdown across the igniter and the initial formation of a plasma. The transformers may also be constructed such that the secondary saturates during the capacitor 912, 922 discharges, as discussed above.

The construction and operation of Channel B is the same as Channel A, with capacitor 922 being charged by the HV_MAIN through diode 920 and MOSFET 926 being operated using CTRL_2 from the control circuit 960 to discharge capacitor 922 through the primary of transformer 924 such that the secondary of that transformer initiates breakdown at igniter 928 via the same Shared Circuitry components 930, 932, 934 as discussed above, depending on the transformer wiring convention used.

The Shared Circuitry includes energy storage devices (capacitors 942, 944) that are used to provide subsequent, follow-on electrical energy to the igniters 918, 928 immediately after the initial breakdown and plasma formation. This is done by the control circuit 960 outputting one or more positive pulses on CTRL_3 that simultaneously operates IGBTs 946, 948 to discharge the capacitors 942, 944 through the secondary of whichever igniter is currently firing. Upon transistors 946, 948 turning on, diode 950 forces ground to rise to near the HV_MAIN voltage and those capacitors to discharge through ground into the firing igniter 918 or 928 and then through the secondary of the associated transformer and back to the capacitor via inductor 940. Because the subsequent pulse(s) generated by the shared circuitry may be created while the transformer secondary is still saturated, inductor 940 provides some additional impedance to limit the current.

When the transformers are constructed using the alternative winding direction discussed above, the subsequent current pulse(s) will flow through the igniter and transformer in the same direction as the initial breakdown current from the associated channel MOSFET.

Thus, it will be appreciated that this circuit uses a shared energy storage device for each of the two separate channels (exciters) and igniters. This allows for a reduction in what can be physically large energy storage components and a simplified circuitry for systems having multiple plasma generation circuitry. And, with suitable sizing of the energy storage devices, this allows for operation of the plasma events (breakdown and subsequent pulses) without substantially or fully depleting the shared circuitry energy storage devices, such that a continuous current can be maintained through the igniter throughout the overall plasma firing event. See, for example, FIGS. 5A-5D in which the current does not fall to zero between the different follow-on pulses.

The foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

### Inventive Aspects

The following paragraphs are statements defining various aspects of the invention in claim format for present or future use as patent claims. These paragraphs represent at least some of the inventive aspects for which protection is sought.

1. A plasma generation system, comprising:
a plurality of plasma generators, each plasma generator comprising at least two electrodes configured to form plasma between the at least two electrodes of the plasma generator when a breakdown voltage sufficient to induce breakdown between the at least two electrodes is applied thereto; and
circuitry configured to, for each of the plurality of plasma generators, following breakdown, control application of electrical energy to the at least two electrodes of the plasma generator, the application of electrical energy to the at least two electrodes being along a shared electrical energy flow path that is shared by each of the plurality of plasma generators.

2. The plasma generation system of inventive aspect 1, wherein the circuitry is configured to, for each of the plurality of plasma generators, following breakdown, actively control the application of electrical energy to the at least two electrodes of the plasma generator.

3. The plasma generation system of inventive aspect 1 or 2, wherein the circuitry comprises multiplexing circuitry interconnecting each of the plurality of plasma generators to the shared electrical energy flow path to deliver electrical energy via the shared electrical energy flow path to each of the plurality of plasma generators.

4. The plasma generation system of inventive aspect 3, wherein the multiplexing circuitry comprises, for each of the plurality of plasma generators, a respective switching element coupled to the plasma generator and configured to control coupling between the plasma generator and the shared electrical energy flow path that is shared by each of the plurality of plasma generators.

5. The plasma generation system of any one of inventive aspects 1 to 4, wherein the circuitry is configured to, following application of the breakdown voltage to the at least two electrodes, via the shared electrical energy flow path, control application of a pulse of electrical energy sufficient to prevent total recombination of plasma formed between the at least two electrodes.

6. The plasma generation system of inventive aspect 5, wherein the pulse of electrical energy is further sufficient to propagate the plasma toward a distal tip of the at least two electrodes.

7. The plasma generation system of any one of inventive aspects 1 to 6, wherein following breakdown, for each of the plurality of plasma generators, a point along the at least two electrodes to and/or from which electrical energy is discharged moves along a length of the at least two electrodes.

8. The plasma generation system of any one of inventive aspects 1 to 7, wherein, for each of the plurality of plasma generators, the electrical energy is sufficient to produce a Lorentz force component along the at least two electrodes.

9. The plasma generation system of any one of inventive aspects 1 to 8, wherein the circuitry comprises a shared circuit component that is coupled to each of the plurality of plasma generators via the shared electrical energy flow path.

10. The plasma generation system of inventive aspect 9, wherein the shared circuit component comprises a shared inductance that is coupled to each of the plurality of plasma generators via the shared electrical energy flow path.

11. The plasma generation system of inventive aspect 10, wherein, the shared inductance comprises a shared transformer.

12. The plasma generation system of inventive aspect 11, wherein the shared transformer comprises a saturable core.

13. The plasma generation system of inventive aspect 12, wherein the shared transformer is configured to keep the saturable core at least partially saturated at least from breakdown until the application of electrical energy following breakdown.

14. The plasma generation system of inventive aspect 9 or 10, wherein the shared circuit component comprises a shared switching element that is coupled to each of the plurality of plasma generators via the shared electrical energy flow path.

15. The plasma generation system of any one of inventive aspects 9 to 14, wherein the shared circuit component comprises a shared energy storage device that is coupled to each of the plurality of plasma generators via the shared electrical energy flow path.

16. The plasma generation system of inventive aspect 15, wherein the shared energy storage device comprises a shared capacitor configured to store the electrical energy to be delivered to each of the plurality of plasma generators.

17. The plasma generation system of inventive aspect 15 or 16, wherein the circuitry is configured to terminate delivery of electrical energy to at least one plasma generator of the plurality of plasma generators, with the shared energy storage device storing at least some additional electrical energy after termination of delivery.

18. The plasma generation system of inventive aspect 17, wherein the at least some additional electrical energy is sufficient to prevent total recombination of plasma formed between the at least two electrodes of the at least one plasma generator.

19. The plasma generation system of inventive aspect 17 or 18, wherein the circuitry is further configured to, after terminating delivery of electrical energy to the at least one plasma generator, deliver, to at least one second plasma generator of the plurality of plasma generators, using at least some of the additional electrical energy stored in the shared energy storage device, electrical energy sufficient to prevent total recombination of plasma formed between the at least two electrodes of the at least one second plasma generator.

20. The plasma generation system of any one of inventive aspects 17 to 19, wherein the circuitry is further configured to deliver the breakdown voltage to the at least one plasma generator and, after delivering the breakdown voltage, apply follow-on energy to the at least one plasma generator sufficient to prevent total recombination of the plasma between the at least two electrodes of the at least one plasma generator.

21. The plasma generation system of inventive aspect 20, wherein the follow-on energy is further sufficient to propagate the plasma toward a distal tip of the at least two electrodes of the at least one plasma generator.

22. The plasma generation system of inventive aspect 21, wherein propagating the plasma toward the distal tip moves a point at which the electrical energy is discharged to and/or from the at least two electrodes.

23. The plasma generation system of any one of inventive aspects 15 to 22, further comprising, for each of the plurality of plasma generators, an inductance coupled between the shared energy storage device and the plasma generator.

24. The plasma generation system of inventive aspect 23, wherein, for each of the plurality of plasma generators:

the inductance comprises a transformer coupled between the shared energy storage device and the plasma generator and comprising a saturable core.

25. The plasma generation system of inventive aspect 24, wherein the transformer is configured to keep the saturable core at least partially saturated at least from breakdown until a controlled delivery of electrical energy from the shared energy storage device to the plasma generator following breakdown.

26. The plasma generation system of inventive aspect 23 or 24, wherein, for each of the plurality of plasma generators, a path including the plasma generator, the inductance, and the shared energy storage device is switchable to terminate delivery of electrical energy from the shared energy storage device to the plasma generator via the inductance with at least some additional electrical energy remaining in the shared energy storage device.

27. The plasma generation system of any one of inventive aspects 15 to 26, wherein the shared energy storage device is configured to store more than an amount of electrical energy needed to apply the breakdown voltage to each of the plurality of plasma generators collectively.

28. The plasma generation system of any one of inventive aspects 15 to 27, wherein:
the shared electrical energy flow path includes the plasma generator and the shared energy storage device, and
the circuitry comprises, for each of the plurality of plasma generators, a switching element coupled in the shared electrical energy flow path that is configured to terminate delivery of electrical energy from the shared energy storage device to the at least two electrodes with at least some additional electrical energy remaining in the shared energy storage device.

29. A plasma generation system, comprising:
a plurality of plasma generators, each plasma generator comprising at least two electrodes configured to form plasma between the at least two electrodes of the plasma generator when a breakdown voltage sufficient to induce breakdown between the at least two electrodes is applied thereto; and
a controlled energy discharge path configured to apply, to the at least two electrodes of each of the plurality of plasma generators, electrical energy sufficient to propagate the plasma toward a distal tip of the at least two electrodes.

30. The plasma generation system of inventive aspect 29, wherein, for each of the plurality of plasma generators, the electrical energy is further sufficient to move a point of discharge of electrical energy to and/or from the at least two electrodes.

31. The plasma generation system of inventive aspect 29 or 30, wherein, for each of the plurality of plasma generators, the electrical energy is sufficient to produce a Lorentz force component along the at least two electrodes.

32. The plasma generation system of inventive aspect 29, wherein the controlled energy discharge path is configured to apply, for each of the plurality of plasma generators, to the at least two electrodes of the plasma generator, after the breakdown voltage is applied to the plasma generator, the electrical energy sufficient to propagate the plasma toward the distal tip of the at least two electrodes.

33. The plasma generation system of inventive aspect 29 or 32, wherein the controlled energy discharge path is further configured to apply, to the at least two electrodes of each of the plurality of plasma generators, the breakdown voltage, resulting in formation of the plasma between the at least two electrodes of each of the plurality of plasma generators.

34. The plasma generation system of any one of inventive aspects 29 to 33, wherein the controlled energy discharge path comprises a shared circuit component that is coupled to each of the plurality of plasma generators.

35. The plasma generation system of inventive aspect 34, wherein the shared circuit component comprises a shared inductance that is coupled to each of the plurality of plasma generators.

36. The plasma generation system of inventive aspect 35, wherein, the shared inductance comprises a shared transformer.

37. The plasma generation system of inventive aspect 36, wherein the shared transformer comprises a saturable core.

38. The plasma generation system of inventive aspect 37, wherein the shared transformer is configured to keep the saturable core at least partially saturated at least from breakdown until application of electrical energy following breakdown.

39. The plasma generation system of inventive aspect 34 or 35, wherein the shared circuit component comprises a shared switching element that is coupled to each of the plurality of plasma generators.

40. The plasma generation system of any one of inventive aspects 34 to 39, wherein the shared circuit component comprises a shared energy storage device that is coupled to each of the plurality of plasma generators.

41. The plasma generation system of inventive aspect 40, wherein the shared energy storage device is configured to store more than an amount of electrical energy needed to apply the breakdown voltage to each of the plurality of plasma generators collectively.

42. The plasma generation system of inventive aspect 40 or 41, wherein the shared energy storage device comprises a shared capacitor configured to store the at least some of the electrical energy for applying to each of the plurality of plasma generators.

43. The plasma generation system of any one of inventive aspects 40 to 42, wherein the controlled energy discharge path is configured to, for each of the plurality of plasma generators, terminate application of electrical energy to the plasma generator with additional stored electrical energy remaining in the shared energy storage device after termination of application of the electrical energy.

44. The plasma generation system of inventive aspect 43, wherein, for each of the plurality of plasma generators, the additional stored electrical energy is sufficient to prevent total recombination of plasma formed between the at least two electrodes of the plasma generator.

45. The plasma generation system of inventive aspect 43 or 44, wherein the controlled energy discharge path is further configured to, for each of the plurality of plasma generators, after terminating application of the electrical energy to the plasma generator, apply, to the plasma generator, using at least some of the additional stored electrical energy remaining in the shared energy storage device, additional electrical energy.

46. The plasma generation system of inventive aspect 45, wherein, for each of the plurality of plasma generators, the electrical energy is sufficient to propagate the plasma toward a distal tip of the at least two electrodes and the additional electrical energy is sufficient to further propagate the plasma toward the distal tip of the at least two electrodes.

47. The plasma generation system of any one of inventive aspects 40 to 46, wherein the controlled energy discharge path comprises, for each of the plurality of plasma generators, a switching element coupled in the controlled energy discharge path and configured to terminate a supply of electrical energy from the shared energy storage device to the plasma generator with additional stored electrical energy remaining in the shared energy storage device.

48. The plasma generation system of inventive aspect 47, wherein, for each of the plurality of plasma generators, the additional stored electrical energy is sufficient to prevent total recombination of plasma formed between the at least two electrodes of the plasma generator.

49. The plasma generation system of any one of inventive aspects 40 to 48, wherein the controlled energy discharge path comprises, for each of the plurality of plasma generators, an inductance coupled between the shared energy storage device and the plasma generator.

50. The plasma generation system of inventive aspect 49, wherein, for each of the plurality of plasma generators:
the inductance comprises a transformer coupled between the shared energy storage device and the plasma generator and comprising a saturable core.

51. The plasma generation system of inventive aspect 50, wherein the transformer is configured to keep the saturable core at least partially saturated at least from application of the breakdown voltage until controlled application of electrical energy following breakdown.

52. The plasma generation system of any one of inventive aspects 49 to 51, wherein, for each of the plurality of plasma generators, the controlled energy discharge path includes the plasma generator, the inductance, and the shared energy storage device and the controlled energy discharge path is switchable to terminate a supply of electrical energy from the shared energy storage device to the at least two electrodes via the inductance with additional stored electrical energy remaining in the shared energy storage device.

53. A plasma generation system, comprising:
a plurality of plasma generators, each plasma generator comprising at least two electrodes configured to form plasma between the at least two electrodes of the plasma generator when a breakdown voltage sufficient to induce breakdown between the at least two electrodes is applied thereto;
an energy storage device; and
circuitry coupled to the energy storage device and to each of the plurality of plasma generators and configured to deliver electrical energy from the energy storage device to each of the plurality of plasma generators,
wherein the energy storage device is configured to store an amount of electrical energy greater than needed to apply the breakdown voltage to each of the plurality of plasma generators collectively.

54. The plasma generation system of inventive aspect 53, wherein the amount of electrical energy is sufficient to, after applying the breakdown voltage to each of the plurality of plasma generators, further apply the breakdown voltage to at least one plasma generator of the plurality of plasma generators.

55. The plasma generation system of inventive aspect 54, wherein the amount of electrical energy is further sufficient to, after applying the breakdown voltage to each of the plurality of plasma generators and applying the breakdown voltage to the at least one plasma generator, further apply to the at least one plasma generator follow-on energy sufficient to prevent total recombination of plasma formed between the at least two electrodes of the at least one plasma generator.

56. The plasma generation system of inventive aspect 55, wherein the follow-on energy is further sufficient to propagate the plasma toward a distal tip of the at least two electrodes of the at least one plasma generator.

57. The plasma generation system of inventive aspect 56, wherein the follow-on energy is further sufficient to move a point at which electrical energy is discharged to and/or from the at least two electrodes.

58. The plasma generation system of any one of inventive aspects 55 to 57, wherein the amount of electrical energy is at least 150% of electrical energy needed to apply, to each of the plurality of plasma generators collectively, the breakdown voltage and follow-on electrical energy sufficient to prevent total recombination of plasma formed by the breakdown voltage.

59. The plasma generation system of any one of inventive aspects 55 to 58, wherein the amount of electrical energy is at least 200% of electrical energy needed to apply, to each of the plurality of plasma generators collectively, the breakdown voltage and follow-on electrical energy sufficient to prevent total recombination of plasma formed by the breakdown voltage.

60. The plasma generation system of any one of inventive aspects 53 to 59, wherein the energy storage device comprises a capacitor configured to store the amount of electrical energy.

61. The plasma generation system of any one of inventive aspects 53 to 60, wherein the circuitry is configured to terminate application of electrical energy to at least one plasma generator of the plurality of plasma generators with the energy storage device storing at least some additional electrical energy after termination of application of electrical energy.

62. The plasma generation system of inventive aspect 61, wherein the circuitry is further configured to, after terminating application of electrical energy to the at least one plasma generator, apply, to at least one second plasma generator of the plurality of plasma generators, electrical energy in a second amount sufficient to prevent total recombination of plasma formed between at least two second electrodes of the at least one second plasma generator.

63. The plasma generation system of inventive aspect 62, wherein the electrical energy is delivered to the at least one plasma generator in an amount further sufficient to propagate the plasma toward a distal tip of the at least two electrodes of the at least one plasma generator.

64. The plasma generation system of inventive aspect 63, wherein the electrical energy is in an amount sufficient to move a point at which electrical energy is discharged to and/or from the at least two electrodes of the at least one plasma generator.

65. The plasma generation system of any one of inventive aspects 53 to 64, further comprising, for each of the plurality of plasma generators, an inductance coupled between the energy storage device and the plasma generator.

66. The plasma generation system of inventive aspect 65, wherein, for each of the plurality of plasma generators:
the inductance comprises a transformer coupled between the energy storage device and the plasma generator and comprising a saturable core.

67. The plasma generation system of inventive aspect 66, wherein the transformer is configured to keep the saturable core at least partially saturated at least from breakdown until delivery of the electrical energy, wherein the electrical energy is in an amount sufficient to prevent total recombination and delivered following breakdown.

68. The plasma generation system of any one of inventive aspects 65 to 67, wherein, for each of the plurality of plasma generators, a path including the plasma generator, the inductance, and the energy storage device is switchable to terminate delivery of electrical energy from the energy storage device to the plasma generator via the inductance with additional electrical energy remaining stored in the energy storage device.

69. The plasma generation system of any one of inventive aspects 53 to 68, wherein the circuitry comprises, for each of the plurality of plasma generators, a switching element coupled in a path that includes the plasma generator and the energy storage device and configured to terminate a supply of electrical energy from the energy storage device to the at least two electrodes with additional electrical energy remaining stored in the energy storage device.

70. An ignition system, comprising:
a first igniter comprising a first plurality of electrodes;
a second igniter comprising a second plurality of electrodes; and
a controlled energy discharge path configured to:
   apply a first pulse of electrical energy to the first plurality of electrodes following breakdown between the first plurality of electrodes; and
   apply a second pulse of electrical energy to the second plurality of electrodes following breakdown between the second plurality of electrodes.

71. The ignition system of inventive aspect 70, wherein:
the first pulse of electrical energy is sufficient to prevent total recombination of plasma formed between the first plurality of electrodes; and
the second pulse of electrical energy is sufficient to prevent total recombination of plasma formed between the second plurality of electrodes.

72. The ignition system of inventive aspect 71, wherein:
the first pulse of electrical energy is further sufficient to propagate the plasma formed between the first plurality of electrodes toward a distal tip of the first plurality of electrodes; and
the second pulse of electrical energy is further sufficient to propagate the plasma formed between the second plurality of electrodes toward a distal tip of the second plurality of electrodes.

73. The ignition system of inventive aspect 72, wherein the first pulse of electrical energy is sufficient to move a point at which electrical energy is discharged to and/or from the first plurality of electrodes and the second pulse of electrical energy is sufficient to move a point at which electrical energy is discharged to and/or from the second plurality of electrodes.

74. The ignition system of any one of inventive aspects 70 to 73, wherein the first pulse of electrical energy is sufficient to produce a Lorentz force component along the first plurality of electrodes and the second pulse of electrical energy is sufficient to produce a Lorentz force component along the second plurality of electrodes.

75. The ignition system of any one of inventive aspects 70 to 74, wherein the controlled energy discharge path comprises a first switching element configured to control application of electrical energy to the first plurality of electrodes and a second switching element configured to control application of electrical energy to the second plurality of electrodes.

76. The ignition system of any one of inventive aspects 70 to 75, wherein the controlled energy discharge path comprises a shared circuit component that is coupled to each of the first igniter and the second igniter.

77. The ignition system of inventive aspect 76, wherein the shared circuit component comprises a shared inductance that is coupled to each of the first igniter and the second igniter.

78. The ignition system of inventive aspect 77, wherein, the shared inductance comprises a shared transformer comprising a core.

79. The ignition system of inventive aspect 78, wherein the shared transformer is configured to keep the core at least partially saturated at least from breakdown until application of electrical energy following breakdown.

80. The ignition system of any one of inventive aspects 76 to 79, wherein the shared circuit component comprises a shared switching element that is coupled to each of the first igniter and the second igniter.

81. The ignition system of any one of inventive aspects 76 to 80, wherein the shared circuit component comprises a shared energy storage device that is coupled to each of the first igniter and the second igniter.

82. The ignition system of inventive aspect 81, wherein the shared energy storage device comprises a shared capacitor.

83. The ignition system of inventive aspect 82, wherein the shared capacitor is configured to store an amount of electrical energy greater than a sum of:
a first amount of electrical energy needed to apply, to the first plurality of electrodes, a breakdown voltage sufficient to induce breakdown between the first plurality of electrodes, resulting in formation of plasma between the first plurality of electrodes; and
a second amount of electrical energy needed to apply, to the second plurality of electrodes, a breakdown voltage sufficient to induce breakdown between the second amount of electrodes, resulting in formation of plasma between the second plurality of electrodes.

84. The ignition system of any one of inventive aspects 81 to 83, wherein the controlled energy discharge path comprises:
a first switching element coupled in a first portion of the controlled energy discharge path that includes the first igniter and the shared energy storage device and configured to control application of electrical energy stored in the shared energy storage device to the first plurality of electrodes; and
a second switching element coupled in a second portion of the controlled energy discharge path that includes the second igniter and the shared energy storage device and configured to control application of electrical energy stored in the shared energy storage device to the second plurality of electrodes.

85. The ignition system of inventive aspect 84, wherein:
the first switching element is configured to terminate application of electrical energy to the first plurality of electrodes with electrical energy remaining stored in the shared energy storage device; and
the second switching element is configured to terminate application of electrical energy to the second plurality of electrodes with electrical energy remaining stored in the shared energy storage device.

86. The ignition system of inventive aspect 85, wherein:
the electrical energy remaining stored in the shared energy storage device following termination of application of electrical energy to the first plurality of electrodes is sufficient to prevent total recombination of plasma formed between the first plurality of electrodes; and
the electrical energy remaining stored in the shared energy storage device following termination of application of electrical energy to the second plurality of electrodes is sufficient to prevent total recombination of plasma formed between the second plurality of electrodes.

87. The ignition system of any one of inventive aspects 81 to 86, wherein the controlled energy discharge path is configured to terminate application of electrical energy to the first plurality of electrodes with electrical energy remaining stored in the shared energy storage device after termination of application of electrical energy to the first plurality of electrodes.

88. The ignition system of inventive aspect 87, wherein the controlled energy discharge path is configured to:
terminate application of electrical energy to the first plurality of electrodes after applying a first pulse of electrical energy; and
apply, to the first plurality of electrodes, using the electrical energy remaining stored in the shared energy storage device after termination of application of electrical energy to the first plurality of electrodes, a second pulse of electrical energy.

89. The ignition system of inventive aspect 88, wherein the first pulse of electrical energy is sufficient to propagate plasma formed between the first plurality of electrodes toward a distal tip of the first plurality of electrodes and the second pulse of electrical energy is sufficient to further propagate the plasma toward the distal tip.

90. The ignition system of any one of inventive aspects 87 to 89, wherein the controlled energy discharge path is configured to apply a third pulse of electrical energy to the second plurality of electrodes using the electrical energy remaining stored in the shared energy storage device after termination of application of electrical energy to the first plurality of electrodes.

91. The ignition system of any one of inventive aspects 81 to 90, wherein the controlled energy discharge path comprises:
a first inductance coupled between the shared energy storage device and the first plurality of electrodes; and
a second inductance coupled between the shared energy storage device and the second plurality of electrodes.

92. The ignition system of inventive aspect 91, wherein:
the first inductance comprises a first transformer coupled between the shared energy storage device and the first igniter and comprising a first core; and
the second inductance comprises a second transformer coupled between the shared energy storage device and the second igniter and comprising a second core.

93. The ignition system of inventive aspect 92, wherein:
the first transformer is configured to keep the first core at least partially saturated at least from breakdown between the first plurality of electrodes until application of the first pulse of electrical energy following breakdown between the first plurality of electrodes; and
the second transformer is configured to keep the second core at least partially saturated at least from breakdown between the second plurality of electrodes until application of the second pulse of electrical energy following breakdown between the second plurality of electrodes.

94. A plasma generation system, comprising:
a plurality of plasma generators, each plasma generator comprising at least two electrodes;
a plurality of energy flow paths to the plurality of plasma generators, respectively, wherein the plurality of energy flow paths share a shared circuit component; and
a plurality of transformers, for each of the plurality of plasma generators, respectively, each transformer comprising:
   a primary coil configured to trigger breakdown between the at least two electrodes, resulting in formation of plasma between the at least two electrodes; and
   a secondary coil configured to receive, along the energy flow path to the plasma generator and via the shared circuit component, electrical energy for applying to the at least two electrodes following breakdown.

95. The plasma generation system of inventive aspect 94, wherein, for each of the plurality of plasma generators, the electrical energy is sufficient to prevent total recombination of plasma formed between the at least two electrodes of the plasma generator.

96. The plasma generation system of inventive aspect 95, further comprising circuitry configured to apply, to the at least two electrodes of each of the plurality of plasma generators, a breakdown voltage sufficient to induce breakdown between the at least two electrodes resulting in formation of the plasma.

97. The plasma generation system of any one of inventive aspects 94 to 96, wherein, for each of the plurality of plasma generators, the electrical energy is further sufficient to propagate the plasma toward a distal tip of the at least two electrodes.

98. The plasma generation system of any one of inventive aspects 94 to 97, wherein, for each of the plurality of plasma generators, the electrical energy is sufficient to move a point of discharge of electrical energy to and/or from the at least two electrodes.

99. The plasma generation system of any one of inventive aspects 94 to 98, wherein, for each of the plurality of plasma generators, the electrical energy is sufficient to produce a Lorentz force component along the at least two electrodes.

100. The plasma generation system of any one of inventive aspects 94 to 99, further comprising, for each of the plurality of plasma generators, in the energy flow path, a switching element coupled to the shared circuit component and to the plasma generator.

101. The plasma generation system of any one of inventive aspects 94 to 100, wherein the shared circuit component comprises a shared switching element that is coupled to each of the plurality of plasma generators.

102. The plasma generation system of any one of inventive aspects 94 to 101, wherein the shared circuit component comprises a shared energy storage device that is coupled to each of the plurality of plasma generators.

103. The plasma generation system of inventive aspect 102, wherein the shared energy storage device is configured to store an amount of electrical energy greater than needed to apply, to each of the plurality of plasma generators collectively, a breakdown voltage sufficient to induce breakdown between the at least two electrodes of the plasma generator.

104. The plasma generation system of inventive aspect 102 or 103, further comprising, for each of the plurality of plasma generators, a switching element configured to terminate application of electrical energy to the at least two electrodes of the plasma generator with at least some electrical energy remaining stored in the shared energy storage device.

105. The plasma generation system of inventive aspect 104, wherein, for each of the plurality of plasma generators, the at least some electrical energy remaining stored in the shared energy storage device is sufficient to prevent total recombination of plasma formed between the at least two electrodes.

106. The plasma generation system of any one of inventive aspects 102 to 105, wherein the shared energy storage device comprises a shared capacitor that is coupled to each of the plurality of plasma generators and configured to store the electrical energy for applying to the at least two electrodes of each of the plurality of plasma generators.

107. The plasma generation system of any one of inventive aspects 102 to 106, further comprising circuitry configured to terminate application of electrical energy to the at least two electrodes of at least one plasma generator of the plurality of plasma generators with at least some electrical energy remaining stored in the shared energy storage device.

108. The plasma generation system of inventive aspect 107, wherein the circuitry is configured to apply, to the at least two electrodes of at least one second plasma generator of the plurality of plasma generators, using the at least some electrical energy remaining stored in the shared energy storage device, electrical energy sufficient to prevent total recombination of plasma formed between the at least two electrodes of the at least one second plasma generator.

109. The plasma generation system of inventive aspect 107 or 108, wherein the circuitry is configured to apply, to the at least two electrodes of the at least one plasma generator, using the at least some electrical energy remaining stored in the shared energy storage device, additional electrical energy sufficient to prevent total recombination of the plasma formed between the at least two electrodes of the at least one plasma generator.

110. The plasma generation system of inventive aspect 109, wherein the electrical energy applied to the at least two electrodes of the at least one plasma generator is sufficient to propagate the plasma toward a distal tip of the at least two electrodes of the at least one plasma generator and the additional electrical energy applied to the at least two electrodes of the at least one plasma generator is sufficient to further propagate the plasma toward the distal tip of the at least two electrodes of the at least one plasma generator.

111. The plasma generation system of any one of inventive aspects 94 to 110, wherein, for each of the plurality of plasma generators:
the transformer comprises a saturable core, and
the transformer is configured to keep the saturable core at least partially saturated at least from breakdown between the at least two electrodes until application of electrical energy to the at least two electrodes following breakdown.

112. The plasma generation system of inventive aspect 110 or 111, wherein, for each of the plurality of plasma generators, the energy flow path is switchable to terminate delivery of electrical energy from the shared energy storage device to the plasma generator via the secondary coil with at least some electrical energy remaining stored in the shared energy storage device.

113. A plasma generation system, comprising:
a plurality of plasma generators, each plasma generator comprising at least two electrodes configured to form plasma between the at least two electrodes of the plasma generator when a breakdown voltage sufficient to induce breakdown between the at least two electrodes is applied thereto;
an energy storage device; and
circuitry configured to:
   apply, to each of the plurality of plasma generators, using electrical energy stored in the energy storage device, a pulse of electrical energy; and
   for each of the plurality of plasma generators, terminate application of the pulse of electrical energy with at least some electrical energy remaining stored in the energy storage device.

114. The plasma generation system of inventive aspect 113, wherein, for each of the plurality of plasma generators, the at least some electrical energy remaining stored in the energy storage device is sufficient to prevent total recombination of plasma formed between the at least two electrodes of the plasma generator.

115. The plasma generation system of inventive aspect 113 or 114, wherein the circuitry is further configured to, for each of the plurality of plasma generators, after terminating application of the electrical energy to the plasma generator, apply, to the plasma generator, using at least some of the at least some electrical energy remaining stored in the energy storage device, additional electrical energy.

116. The plasma generation system of inventive aspect 115, wherein, for each of the plurality of plasma generators, the pulse of electrical energy is sufficient to propagate the plasma toward a distal tip of the at least two electrodes and the additional electrical energy is sufficient to further propagate the plasma toward the distal tip of the at least two electrodes.

117. The plasma generation system of any one of inventive aspects 113 to 116, wherein, for each of the plurality of plasma generators, the pulse of electrical energy is sufficient to move a point of discharge of electrical energy to and/or from the at least two electrodes.

118. The plasma generation system of any one of inventive aspects 113 to 117, wherein, for each of the plurality of plasma generators, the pulse of electrical energy is sufficient to produce a Lorentz force component along the at least two electrodes.

119. The plasma generation system of any one of inventive aspects 113 to 118, wherein the circuitry is configured to apply, for each of the plurality of plasma generators, to the at least two electrodes of the plasma generator, after the breakdown voltage is applied to the plasma generator, the pulse of electrical energy, wherein the pulse of electrical energy is sufficient to prevent total recombination of the plasma.

120. The plasma generation system of inventive aspect 119, wherein for each of the plurality of plasma generators, the pulse of electrical energy is further sufficient to propagate the plasma toward a distal tip of the at least two electrodes.

121. The plasma generation system of inventive aspect 113 to 120, wherein the circuitry is further configured to apply, to the at least two electrodes of each of the plurality of plasma generators, the breakdown voltage, resulting in formation of the plasma between the at least two electrodes of each of the plurality of plasma generators.

122. The plasma generation system of any one of inventive aspects 113 to 121, wherein the energy storage device is configured to store more than an amount of electrical energy needed to apply the breakdown voltage to each of the plurality of plasma generators collectively.

123. The plasma generation system of inventive aspect 122, wherein the energy storage device comprises a capacitor configured to store the electrical energy for applying to each of the plurality of plasma generators.

124. The plasma generation system of any one of inventive aspects 113 to 123, wherein the circuitry comprises, for each of the plurality of plasma generators, a switching element coupled to the plasma generator and to the energy storage device and configure to terminate application of electrical energy from the energy storage device to the plasma generator with at least some electrical energy remaining stored in the energy storage device.

125. The plasma generation system of any one of inventive aspects 113 to 124, wherein the circuitry comprises, for each of the plurality of plasma generators, an inductance coupled between the energy storage device and the plasma generator.

126. The plasma generation system of inventive aspect 125, wherein, for each of the plurality of plasma generators:
the inductance comprises a transformer coupled between the energy storage device and the plasma generator and comprising a saturable core.

127. The plasma generation system of inventive aspect 126, wherein the transformer is configured to keep the saturable core at least partially saturated at least from application of the breakdown voltage until application of the pulse of electrical energy, and wherein the application of the pulse of electrical energy is following breakdown.

128. The plasma generation system of any one of inventive aspects 125 to 127, wherein, for each of the plurality of plasma generators, a path that includes the plasma generator, the inductance, and the energy storage device is switchable to terminate application of electrical energy from the energy storage device to the at least two electrodes via the inductance with at least some electrical energy remaining stored in the energy storage device.

1. A plasma generation system, comprising:
a plurality of plasma generators, each plasma generator comprising at least two electrodes configured to form plasma between the at least two electrodes of the plasma generator when a breakdown voltage sufficient to induce breakdown between the at least two electrodes is applied thereto; and
circuitry configured to, for each of the plurality of plasma generators, following breakdown, control application of electrical energy to the at least two electrodes of the plasma generator, the application of electrical energy to the at least two electrodes being along a shared electrical energy flow path that is shared by each of the plurality of plasma generators.

2. The plasma generation system of claim 1, wherein the circuitry is configured to, for each of the plurality of plasma generators, following breakdown, actively control the application of electrical energy to the at least two electrodes of the plasma generator.

3. The plasma generation system of claim 1, wherein the circuitry comprises multiplexing circuitry interconnecting each of the plurality of plasma generators to the shared electrical energy flow path to deliver electrical energy via the shared electrical energy flow path to each of the plurality of plasma generators.

4. The plasma generation system of claim 3, wherein the multiplexing circuitry comprises, for each of the plurality of plasma generators, a respective switching element coupled to the plasma generator and configured to control coupling between the plasma generator and the shared electrical energy flow path that is shared by each of the plurality of plasma generators.

5. The plasma generation system of claim 1, wherein the circuitry is configured to, following application of the breakdown voltage to the at least two electrodes, via the shared electrical energy flow path, control application of a pulse of electrical energy sufficient to prevent total recombination of plasma formed between the at least two electrodes.

6. The plasma generation system of claim 5, wherein the pulse of electrical energy is further sufficient to propagate the plasma toward a distal tip of the at least two electrodes.

7. The plasma generation system of claim 1, wherein following breakdown, for each of the plurality of plasma generators, a point along the at least two electrodes to and/or from which electrical energy is discharged moves along a length of the at least two electrodes.

8. The plasma generation system of claim 1, wherein, for each of the plurality of plasma generators, the electrical energy is sufficient to produce a Lorentz force component along the at least two electrodes.

9. The plasma generation system of claim 1, wherein the circuitry comprises a shared circuit component that is coupled to each of the plurality of plasma generators via the shared electrical energy flow path.

10. The plasma generation system of claim 9, wherein the shared circuit component comprises a shared inductance that is coupled to each of the plurality of plasma generators via the shared electrical energy flow path.

11. The plasma generation system of claim 9, wherein the shared circuit component comprises a shared switching element that is coupled to each of the plurality of plasma generators via the shared electrical energy flow path.

12. The plasma generation system of claim 9, wherein the shared circuit component comprises a shared energy storage device that is coupled to each of the plurality of plasma generators via the shared electrical energy flow path.

13. The plasma generation system of claim 12, wherein the shared energy storage device comprises a shared capacitor configured to store the electrical energy to be delivered to each of the plurality of plasma generators.

14. The plasma generation system of claim 12, wherein the circuitry is configured to terminate delivery of electrical energy to at least one plasma generator of the plurality of plasma generators, with the shared energy storage device storing at least some additional electrical energy after termination of delivery.

15. The plasma generation system of claim 14, wherein the at least some additional electrical energy is sufficient to prevent total recombination of plasma formed between the at least two electrodes of the at least one plasma generator.

16. The plasma generation system of claim 14, wherein the circuitry is further configured to, after terminating delivery of electrical energy to the at least one plasma generator, deliver, to at least one second plasma generator of the plurality of plasma generators, using at least some of the additional electrical energy stored in the shared energy storage device, electrical energy sufficient to prevent total recombination of plasma formed between the at least two electrodes of the at least one second plasma generator.

17. The plasma generation system of claim 14, wherein the circuitry is further configured to deliver the breakdown voltage to the at least one plasma generator and, after delivering the breakdown voltage, apply follow-on energy to the at least one plasma generator sufficient to prevent total recombination of the plasma between the at least two electrodes of the at least one plasma generator.

18. The plasma generation system of claim 17, wherein the follow-on energy is further sufficient to propagate the plasma toward a distal tip of the at least two electrodes of the at least one plasma generator.

19. The plasma generation system of claim 18, wherein propagating the plasma toward the distal tip moves a point at which the electrical energy is discharged to and/or from the at least two electrodes.

20. The plasma generation system of claim 12, further comprising, for each of the plurality of plasma generators, an inductance coupled between the shared energy storage device and the plasma generator.

21. The plasma generation system of claim 20, wherein, for each of the plurality of plasma generators:
the inductance comprises a transformer coupled between the shared energy storage device and the plasma generator and comprising a saturable core.

22. The plasma generation system of claim 21, wherein the transformer is configured to keep the saturable core at least partially saturated at least from breakdown until a controlled delivery of electrical energy from the shared energy storage device to the plasma generator following breakdown.

23. The plasma generation system of claim 21, wherein, for each of the plurality of plasma generators, a path including the plasma generator, the inductance, and the shared energy storage device is switchable to terminate delivery of electrical energy from the shared energy storage device to the plasma generator via the inductance with at least some additional electrical energy remaining in the shared energy storage device.

24. The plasma generation system of claim 12, wherein the shared energy storage device is configured to store more than an amount of electrical energy needed to apply the breakdown voltage to each of the plurality of plasma generators collectively.

25. The plasma generation system of claim 12, wherein:
the shared electrical energy flow path includes the plasma generator and the shared energy storage device, and
the circuitry comprises, for each of the plurality of plasma generators, a switching element coupled in the shared electrical energy flow path that is configured to terminate delivery of electrical energy from the shared energy storage device to the at least two electrodes with at least some additional electrical energy remaining in the shared energy storage device.
